(19) United States
(12) Patent Application Publication
(10) Pub. No.: US 2017/0010669 A1
(43) Pub. Date: Jan. 12, 2017

(54) METHOD FOR OPERATING ELECTRONIC APPARATUS AND ELECTRONIC APPARATUS SUPPORTING THE METHOD

(71) Applicant: Samsung Electronics Co., Ltd., Suwon-si (KR)

(72) Inventors: Kyung Soo LIM, Yongin-si (KR); Hyuk KANG, Yongin-si (KR); Jae Bong YOO, Seongnam-si (KR); Jong Ho CHOI, Suwon-si (KR); Seung Young JEON, Suwon-si (KR); Duk Ki HONG, Suwon-si (KR)

(21) Appl. No.: 15/120,415

(22) PCT Filed: Feb. 16, 2015
(86) PCT No.: PCT/KR2015/001554

§ 371 Date: Aug. 19, 2016

(30) Foreign Application Priority Data
Feb. 22, 2014 (KR) 10-2014-0020981
Aug. 27, 2014 (KR) 10-2014-0112624

(51) Int. Cl. G06F 3/01; G06F 1/16

(52) U.S. Cl. CPC G06F 3/015; G06F 1/163; G06F 3/017; G06F 3/04886

(57) ABSTRACT

An electronic device operation method and an electronic device for supporting the same are provided. The electronic device operation method includes collecting a signal and determining a state where the electronic device is worn, based on at least one of physiological signal based on at least part of the collected signal, proximity information based on at least part of the collected signal, or illumination information based on at least part of the collected signal.

### CROSS-REFERENCE TO RELATED APPLICATION(S)

This application is a U.S. National Stage application under 35 U.S.C. §371 of an International application filed on Feb. 16, 2015 and assigned application number PCT/KR2015/001554, which claimed the benefit of a Korean patent application filed on Feb. 22, 2014 in the Korean Intellectual Property Office and assigned Serial number 10-2014-0020981, and of a Korean patent application filed on Aug. 27, 2014 in the Korean Intellectual Property Office and assigned Serial number 10-2014-0112624, the entire disclosure of which is hereby incorporated by reference.

### TECHNICAL FIELD

The present disclosure relates to operating electronic devices.

### BACKGROUND

Recently, with the development of digital technologies, a variety of electronic devices, such as mobile communication devices, personal digital assistants (PDAs), electronic notebooks, smartphones, and tablet personal computers (PCs), which perform communication and process personal information while being moved, have been released to the market.

Meanwhile, products of the related art released to the market provide watch functions or provide only amounts of workout using pedometer functions in a state where they are worn on wrists of users. Therefore, compared with watches or pedometers of the related art, the products of the related art do not provide special advantages or convenience.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device operation method for providing an adaptive function based on a form where an electronic device is worn and the electronic device for supporting the same.

Another aspect of the present disclosure is to provide an electronic device operation method for providing an adaptive user interface (UI) based on a form where the electronic device is worn and the electronic device for supporting the same.

Another aspect of the present disclosure is to provide an electronic device operation method for preventing loss of an electronic device by determining whether the electronic device is worn and the electronic device for supporting the same.

In accordance with an aspect of the present disclosure, an electronic device is provided. The electronic device includes a sensor module configured to collect a signal, a module configured to generate physiological signal based on at least part of the collected signal, a module configured to generate proximity information based on at least part of the collected signal, a module configured to generate illumination information based on at least part of the collected signal, and a module configured to determine a state where the electronic device is worn, based on at least one of the physiological signal, the proximity information, or the illumination information.

In accordance with another aspect of the present disclosure, an electronic device operation method is provided. The electronic device operation method includes collecting a signal based on a sensor module and determining a state where an electronic device is worn, based on at least one of physiological signal based on at least part of the collected signal, proximity information based on at least part of the collected signal, or illumination information based on at least part of the collected signal.

According to various embodiments, an electronic device may provide a UI conveniently recognized based on a form where the electronic device is worn.

According to various embodiments, an electronic device may provide a device operation environment corresponding to user preference or a user environment by providing an adaptive function in response to a form where the electronic device is worn.

According to various embodiments, an electronic device may prevent its loss and may output an alarm when the electronic device is lost by checking whether the electronic device is worn.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a drawing illustrating the appearance of an electronic module according to an embodiment of the present disclosure;

FIG. 2 is a block diagram illustrating a configuration of an electronic device operation system according to an embodiment of the present disclosure;

FIG. 3 is a block diagram illustrating a detailed configuration of a mode operation module and a detailed configuration of a storage module according to an embodiment of the present disclosure;

FIG. 4 is a flowchart illustrating a user interface (UI) operation method of an electronic device for each worn state according to an embodiment of the present disclosure;

FIG. 5 is a flowchart illustrating an electronic device operation method for each worn state according to an embodiment of the present disclosure;

FIG. 6 is a flowchart illustrating an electronic device operation method associated with loss prevention according to an embodiment of the present disclosure;

FIG. 7 is a flowchart illustrating an electronic device operation method associated with a training mode according to an embodiment of the present disclosure;

FIG. 8A is a drawing illustrating a mode control based on a state where an electronic device is worn according to an embodiment of the present disclosure;

FIG. 8B is a drawing illustrating a UI control based on a state where an electronic device is worn according to an embodiment of the present disclosure;

FIG. 8C is a drawing illustrating a mode control based on a state where an electronic device is worn according to an embodiment of the present disclosure;

FIG. 9 is a drawing illustrating a graph associated with controlling function execution of an electronic device according to an embodiment of the present disclosure;

FIG. 10 is a drawing illustrating a camera control function of an electronic device according to various embodiments of the present disclosure;

FIG. 11 is a flowchart illustrating a camera control method of an electronic device according to various embodiments of the present disclosure;

FIG. 12 is a drawing illustrating a sensor setting screen according to various embodiments of the present disclosure;

FIG. 13 is a drawing illustrating operation of a heart rate monitor (HRM) sensor according to various embodiments of the present disclosure;

FIG. 14 is a flowchart illustrating a method for controlling a voice search function according to various embodiments of the present disclosure;

FIG. 15 is a drawing illustrating a screen interface associated with a voice recognition function according to various embodiments of the present disclosure;

FIG. 16 is a flowchart illustrating a function conversion method of an HRM sensor according to various embodiments of the present disclosure;

FIG. 17 is a drawing illustrating operation of a scroll function according to various embodiments of the present disclosure;

FIG. 18 is a block diagram illustrating a configuration of an electronic device according to various embodiments of the present disclosure; and

FIG. 19 is a block diagram illustrating a configuration of a program module according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The expressions such as “1st”, “2nd”, “first”, or “second”, and the like used in various embodiments of the present disclosure may refer to various elements irrespective of the order and/or priority of the corresponding elements, but do not limit the corresponding elements. The expressions may be used to distinguish one element from another element. For instance, both “a first user device” and “a second user device” indicate different user devices from each other irrespective of the order and/or priority of the corresponding elements. For example, a first component may be referred to as a second component and vice versa without departing from the scope of the present disclosure.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

Depending on the situation, the expression “configured to” used herein may be used as, for example, the expression “suitable for”, “having the capacity to”, “designed to”, “adapted to”, “made to”, or “capable of”. The term “configured to” must not mean only “specifically designed to” hardwarily. Instead, the expression “a device configured to” may mean that the device is “capable of” operating together with another device or other components. For example, a “processor configured to perform A, B, and C” may mean a generic-purpose processor (e.g., a central processing unit (CPU) or an application processor (AP) which may perform corresponding operations by executing one or more software programs which stores a dedicated processor (e.g., an embedded processor) for performing a corresponding operation.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

Electronic devices according to various embodiments of the present disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Moving Picture Experts Group phase 1 or phase 2 (MPEG-1 or MPEG-2) audio layer 3 (MP3) players, mobile medical devices, cameras, or wearable devices (e.g., smart glasses, head-mounted-devices (HMOs), an electronic apparel, electronic bracelets, electronic necklaces, electronic accessories, electronic tattoos, smart mirrors, or smart watches).

According to various embodiments, the electronic devices may be smart home appliances. The smart home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ and PlayStation™), electronic dictionaries, electronic keys, camcorders, or electronic picture frames.

According to various embodiments, the electronic devices may include at least one of various medical devices (e.g., various portable medical measurement devices (e.g., blood glucose meters, heart rate meters, blood pressure meters, or thermometers, and the like), a magnetic resonance angiography (MRA), a magnetic resonance imaging (MRI), a computed tomography (CT), scanners, or ultrasonic devices, and the like), navigation devices, global navigation satellite system (GNSS), event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to various embodiments, the electronic devices may include at least one of parts of furniture or buildings/structures, electronic boards, electronic signature receiving devices, projectors, or various measuring instruments (e.g., water meters, electricity meters, gas meters, or wave meters, and the like). The electronic devices according to various embodiments of the present disclosure may be one or more combinations of the above-mentioned devices. The electronic devices according to various embodiments of the present disclosure may be flexible electronic devices. Also, electronic devices according to various embodiments of the present disclosure are not limited to the above-mentioned devices, and may include new electronic devices according to technology development

Hereinafter, electronic devices according to various embodiments will be described with reference to the accompanying drawings. The term “user” used herein may refer to a person who uses an electronic device or may refer to a device (e.g., an artificial electronic device) that uses an electronic device.

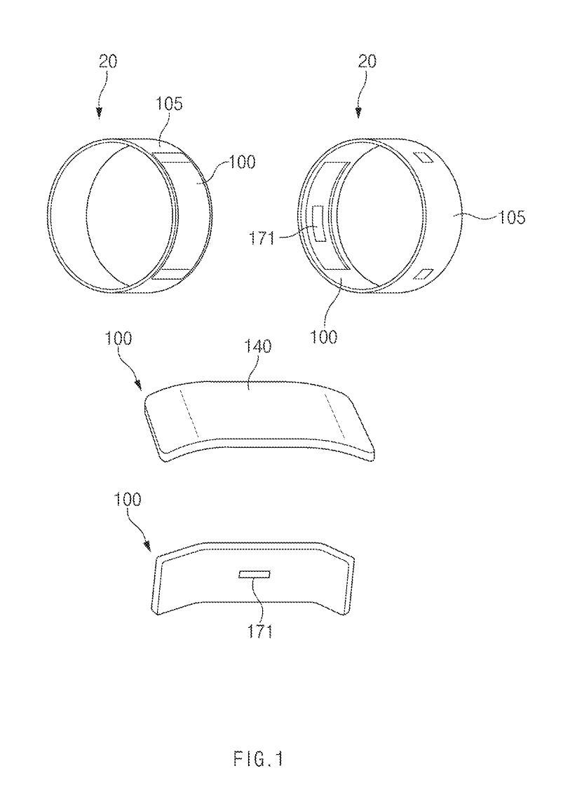

FIG. 1 is a drawing illustrating the appearance of an electronic module according to an embodiment of the present disclosure.

Referring to FIG. 1, an electronic module 20 may be implemented in the form of a ring wearable on various locations such as a wrist, a finger, an ankle and a neck of its user. At least part of the electronic module 20 may be modified in size and shape based on a portion where it is worn. As shown in FIG. 1, the electronic module 20 may include a wearing body 105 of a ring shape and an electronic device 100 disposed at one side of the wearing body 105.

The wearing body 105 may have a certain width and thickness and may be implemented with the ring shape. An adjustment device for expanding a radius of the ring when the electronic module 20 is worn and for reducing the radius of the ring to be fixed to a certain portion after the electronic module 20 is worn may be disposed at at least one side of the wearing body 105. The adjustment device may include at least one of a bending unit, a ring coupling unit, or a hinge unit. The wearing body 105 may be modified in size to various forms based on worn portions. A mounting part where the electronic device 100 is mounted may be installed at one side of the wearing body 105. The mounting part may be implemented with a hole structure which may support the electronic device 100 after the electronic device 100 is mounted. For example, the mounting part may be implemented with a structure which covers an outer portion of the electronic device 100 such that front and rear surfaces of the electronic device 100 are exposed.

The electronic device 100 may be mounted on the mounting portion of the wearing body 105. Also, the electronic device 100 may be removable from the mounting portion of the wearing body 105. At least part of the rear surface of the electronic device 100 may be exposed to an inner side in a state where it is mounted on the wearing body 105. A heart rate monitor (HRM) sensor 171 may be disposed on a region exposed in the state where the electronic device 100 is mounted on the wearing body 105. For example, the HRM sensor 171 may be disposed on the center of the rear surface of the electronic device 100. The electronic device 100 may analyze a sensor signal collected by the HRM sensor 171 and may determine a state or portion where the electronic module 20 is worn. A display module 140 may be arranged on a front surface of the electronic device 100. According to an embodiment, the display module 140 of the electronic device 100 may output a display direction of information in a different way based on a state where the electronic device 100 is worn. According to an embodiment, the electronic device 100 may execute different functions based on a portion where it is worn. According to an embodiment, the electronic device 100 may output information about the same function in a different way based on a portion where it is worn.

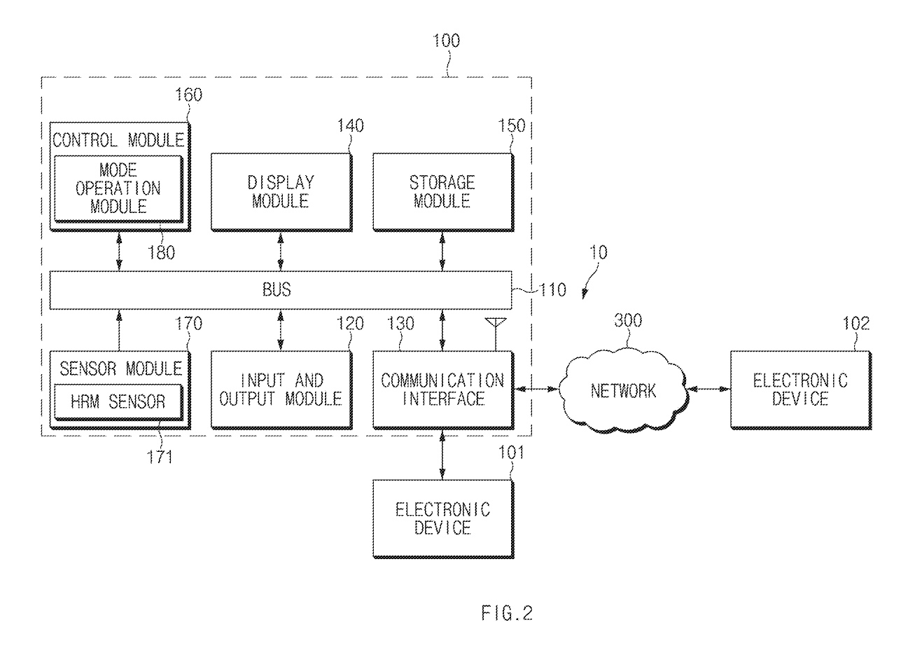

FIG. 2 is a block diagram illustrating a configuration of an electronic device operation system according to an embodiment of the present disclosure.

Referring to FIG. 2, an electronic device operation system 10 according to an embodiment may include an electronic device 100, at least one of electronic devices 101 and 102, and a network 300. The electronic device 100 may be implemented in the form of being wearable on a specific object. The electronic device 100 may analyze a sensor signal of an HRM sensor 171 and may determine whether it is worn. Also, the electronic device 100 may analyze a sensor signal of the HRM sensor 171 and may determine a portion where it is worn.

According to various embodiments, the electronic device 100 and the electronic device 101 may establish a communication channel with each other in a direct communication mode. For example, the electronic device 100 may establish a Bluetooth (BT) direct communication channel with the electronic device 101. Alternatively, the electronic device 100 may establish a Wi-Fi direct communication channel with the electronic device 101.

According to various embodiments, the electronic device 100 may analyze a sensor signal of the HRM sensor 171 included in the electronic device 100 and may send information, about while it is worn, to the electronic device 101. The electronic device 100 may send information, about where it is taken off, to the electronic device 101. The electronic device 100 may send information, about a portion where it is worn, to the electronic device 101. According to various embodiments, the electronic device 100 may send information, about at least one of a state where it is worn or a portion where it is worn, to the electronic device 102 over a network 300.

As shown in FIG. 2, the electronic device 100 may include a bus 110, an input and output module 120, a communication interface 130, a display module 140, a storage module 150 (or memory), a sensor module 170, and a control module 160 (or processor).

The bus 110 may delivery (or send) data between respective components (e.g., the input and output module 120, the communication interface 130, the display module 140, the storage module 150, the sensor module 170 including the HRM sensor 171, and the control module 160) of the electronic device 100. For example, the bus 110 may send an input signal, input from the input and output module 120, to the control module 160. The bus 110 may send a sensor signal of the HRM sensor 171 to the control module 160. The bus 110 may send loss guide information, sent from the control module 160, to the electronic devices 101 and 102 and the like through the communication interface 130. The bus 110 may send reference information (e.g., a reference range), stored in the storage module 150, to the control module 160 in connection with determining a portion where the electronic device 100 is worn.

The input and output module 120 may perform at least one of an input signal generation function or a data output function of the electronic device 100. The input and output module 120 may include a physical key button (e.g., a home key, a side key, a power key, and the like), a jog key, a keypad, and the like. The input and output module 120 may include a virtual keypad, output on the display module 140, as an input device. The input and output module 120 may receive an input signal for activating a specific component, for example, the display module 140, the sensor module 170, the communication module 130, and the like, included in the electronic device 100. According to an embodiment, the input and output module 120 may receive an input signal associated with powering on or off the electronic device 100 and a signal for selecting an information display direction. The signal for selecting the information display direction may be a selection signal associated with whether information is displayed in a transverse direction or a longitudinal direction or whether information is displayed in a different way based on a state or portion where the electronic device is worn. The input and output module 120 may receive an input signal for requesting to execute a specific function application, for example, a health coaching function application and an input signal associated with activating or inactivating an operation mode (or state, or function) for each worn state, for performing an application execution routine in a different way based on a portion where the electronic device 100 is worn. The input and output module 120 may receive an input signal for requesting to activate the sensor module 170, an input signal for requesting to inactivate the sensor module 170, and the like.

According to various embodiments, the input and output module 120 may include an audio module or a multimedia module associated with audio processing. In this regard, the input and output module 120 may include at least one of a speaker or a microphone. The input and output module 120 may output, for example, at least one of audio data corresponding to a state where the electronic device 100 is worn, audio data corresponding to a state where the electronic device 100 is taken off, or audio data corresponding to a state where the electronic device 100 is taken away in a form corresponding to loss. The input and output module 120 may output audio data corresponding to a portion where the electronic device 100 is worn.

According to various embodiments, the input and output module 120 may automatically support a specific audio data output function in response to a portion where the electronic device 100 is worn or may inactivate the corresponding function based on a default setting (or automatically or based on a specific setting). For example, if a rear surface of the electronic device 100 is disposed to be faced with an inner portion of a wrist of the user, the input and output module 120 may inactivate the specific audio data output function based on a default setting. If the rear surface of the electronic device 100 is disposed to be faced with an outer portion of the wrist, the input and output module 120 may activate the specific audio data output function based on the default setting. According to an embodiment, the specific audio data output function may include a function of outputting a sound for providing notification that a communication message is received when the communication message is received, a function of outputting contents of a text message as a text to speech (TTS), a function of outputting an audio based on reproduction of a sound source through a speaker, and the like. The audio data output function of the input and output module 120 may be omitted based on a user setting and the like.

The communication interface 130 (or a communication circuit or a communication circuitry) may support a communication function of the electronic device 100. If the electronic device 100 supports a plurality of communication modes, the communication interface 130 may include a plurality of communication modules. For example, the communication interface 130 may include a local-area communication module or a direct communication module in connection with establishing a direct communication channel. The local-area communication module or the direct communication module may include at least one of various communication modules such as a Wi-Fi direct communication module, a BT communication module, and a ZigBee communication module. If the electronic device 100 supports a communication mode based a base station, the communication interface 130 may include a communication module using a 3^{rd} generation (3G)/4^{th} generation (4G) network (long term evolution (LTE)), a Wi-Fi communication module for supporting a communication mode base on an access point, and the like.

According to an embodiment, the communication interface 130 may send at least one of information about a worn state, information about a worn portion, information about a taken-off state, or loss information to at least one of the electronic devices 101 and 102 under control of the control module 160. The communication interface 130 may receive a control signal or content data (e.g., specific sound source play audio data, warning sound data, and the like) from the electronic devices 101 and 102.

According to an embodiment, the communication interface 130 may send loss information to the electronic device 101. The communication interface 130 may receive a control signal, for requesting to output specific audio data at a certain period or continuously, from the electronic device 101 in response to the sending of the loss information. Alternatively, the communication interface 130 may receive a control signal, for requesting to turn off the display module 140 at a certain period or to constantly maintain the display module 140 with a turned-on state, from the electronic device 101.

According to various embodiments, the communication interface 130 may send information about a taken-off state to the electronic device 101 and may receive an alarm signal from the electronic device 101 after a certain time elapses (e.g. per second, per minute, per hour, per day, and the like, or every six hours, every ten hours, and the like). Herein, the alarm signal may include audio data, control signal for the display module 140, and the like. Alternatively, after sending the information about the taken-off state to the electronic device 101, the communication interface 130 may send a charging request signal based on the remaining capacity of a battery of the electronic device 100 to the electronic device 101. The charging request signal may be output to a display module of the electronic device 101 or may be output through an audio module of the electronic device 101.

The display module 140 may output various screens associated with operating the electronic device 100. For example, the display module 140 may output a lock screen, a waiting screen, and the like. The display module 140 may output a screen of performing a specific function, for example, a screen of executing a sound source play application, a screen of providing notification that a message is received, a screen of verifying message contents, a menu screen, a screen of arranging at least one function item, and the like. According to an embodiment, the display module 140 may output at least one of a screen of guiding a worn state, a screen of guiding a worn portion, a screen of guiding a taken-off state, or a screen of guiding a lost state. In connection with guiding the lost state, the display module 140 may be turned off based on a specific pattern. According to various embodiments, the electronic device 100 may include at least one of a light emitting diode (LED) lamp or a vibration module. The electronic device 100 may output blinking of a specific pattern or a vibration pattern, when an event corresponding to a lost state is generated.

According to various embodiments, when the electronic device 100 is worn, the display module 140 may be automatically activated to output a specific menu screen and a specific function execution screen. After the electronic device 100 is taken off, the display module 140 may display information about the remaining capacity of the battery based on a default setting. After the electronic device 100 is taken off, the display module 140 may be changed to a sleep state based on a default setting. The display module 140 may output guide information for requesting to charge the battery in response to the remaining capacity of the battery. After outputting the screen of guiding the lost state, the display module 140 may be turned off at a certain period or may output a screen of specific brightness or more during a certain time. For example, the display module 140 may output a specific brightness screen at a time requested from the electronic device 101.

According to an embodiment, the display module 140 may display information based on horizontal writing or vertical writing. The display module 140 may change a screen between a landscape mode and a portrait mode. The display module 140 may automatically support one of horizontal writing and vertical writing based on a portion where the electronic device 100 is worn. The display module 140 may automatically output a screen change of the landscape mode or the portrait mode based on the portion where the electronic device is worn.

The storage module 150 may store a variety of information associated with operating the electronic device 100. For example, the storage module 150 may store a specific application executed in the electronic device 100, data based on the execution of the application, and the like. According to an embodiment, the storage module 150 may store an operation application for each worn state. The application program for each worn state may include a routine of collecting physiological signal data (or physiological information) (e.g., a command, a command set or function, a syntax or template associated with the command set or function, or a class, and the like), a routine of analyzing physiological signal data, and a routine of wearing related determination based on the analysis of the physiological signal data. The routine of the wearing related determination may include a routine of determining whether the electronic device 100 is worn, a routine of determining a portion where the electronic device 100 is worn, a routine of determining a state where the electronic device is taken off, a routine of determining a state where the electronic device 100 is lost, and the like.

The sensor module 170 may collect various sensor signals associated with a motion state of the electronic device 100 or conditions around the electronic device 100. For example, the sensor module 170 may include a gyro sensor, an acceleration sensor, an illumination sensor, and the like, associated with detecting motion of the electronic device 100. According to an embodiment, the sensor module 170 may include a physiological sensor, for example, an HRM sensor 171, for detecting a physiological signal of a wearer of the electronic device 100. The sensor module 170 may provide a collected physiological signal (e.g., a photoplethysmography (PPG) signal) to the control module 160. The physiological signal collected by the sensor module 170 may be temporarily or semipermanently stored in the storage module 150. The sensor module 170 may be activated by an input signal of the input and output module 120 or specific scheduled information. After it is determined that the electronic device 100 is taken off, the sensor module 170 may be automatically inactivated. According to various embodiments, when the electronic device 100 is charged, the sensor module 170 may be automatically inactivated. After the charging of the electronic device 100 is completed, the sensor module 170 may be automatically activated.

According to various embodiments, the sensor module 170 may collect a physiological signal corresponding to reference information associated with a worn state and a worn portion. The reference information may be used to analyze a state where the electronic device 100 is worn and a portion where the electronic device 100 is worn, after being stored in the storage module 150. The reference information may be collected through a training mode. The reference information may be updated or learned through history of operating the electronic device 100. For example, the reference information may be collected through at least one of a physiological signal or accumulation data of the physiological signal collected when a specific function is operated in a state where the electronic device 100 is worn, a physiological signal or accumulation data of the physiological signal collected when a specific function is operated in a state where the electronic device 100 is taken off, and a physiological signal or accumulation data of the physiological signal collected when a specific operation is operated on a specific portion where the electronic device 100 is worn.

The control module 160 may process and send data associated with operating the electronic device 100 and may process and send a control signal. According to an embodiment, the control module 160 may activate the sensor module 170 based on an input signal or scheduled information, and the like. The control module 160 may include a mode operation module 180 (e.g., hardware processor) for determining a state where the electronic device 100 is worn, a portion where the electronic device 100 is worn, a state where the electronic device 100 is taken off, and a state where the electronic device 100 is lost. The mode operation module 180 may execute a specific function based on a state of the electronic device 100.

At least one of the electronic device 101 or the electronic device 102 (hereinafter be exemplified as the electronic device 101) may establish a communication channel with the electronic device 100. The electronic device 101 may receive data about a worn state from the electronic device 100. The electronic device 101 (e.g., a smartphone) may send specific content data to the electronic device 100 based on the data about the worn state, received from the electronic device 100, to the electronic device 100 or may output specific audio data (e.g., a warning sound and the like) or a specific message (e.g., a warning message and the like). For example, if receiving loss related information from the electronic device 100, the electronic device 101 may output a guide message for the received loss related information through its display module or its audio module. The electronic device 101 may send a control signal, for controlling the display module 140, the input and output module 120, a vibration module (not shown), and the like of the electronic device 100 in response to user control, to the electronic device 100.

A specific application executed in the electronic device 101 or 102 may request the electronic device 100 to collect a sensor signal of the electronic device 100 and to determine a state and portion where the electronic device 100 is worn, using a remote sensor framework (RSF). Herein, the RSF may be disposed in the electronic devices 100 to 102 and the like. If receiving a request to determine a state where the electronic device 100 is worn from the electronic device 101 or 102, the electronic device 100 may temporarily turn on the HRM sensor 171, may check proximity using signal strength, and may send the checked result to the electronic devices 101 and 102 and the like. If receiving a request to detect a physiological signal of the user of the electronic device 100 from the electronic device 101 or 102, the electronic device 100 may temporarily turn on the HRM sensor 171, may measure the biological signal of the user and may send the measured result to the electronic device 101 and 102. When determining a state and location where the electronic device 100 is worn, the electronic device 100 may collect a sensor signal of an acceleration sensor and a gyro sensor and the like in response to specific scheduling information. For example, if a physiological signal, detected from a sensor signal collected by the HRM sensor 171, has a certain value or less or a value within a specific range, the control module 160 of the electronic device 100 may temporarily activate the acceleration sensor and the gyro sensor. The control module 160 may determine motion of a worn portion based on at least one of a detected acceleration sensor signal or a detected gyro sensor signal and may determine a state and portion, where the electronic device 100 is worn, based on the determined motion.

According to various embodiments, if receiving information based on the wearing of the electronic device 100 from the electronic device 100, the electronic device 101 may send specific audio data to the electronic device 100. If receiving the information based on the wearing of the electronic device 100 from the electronic device 100, the electronic device 101 may send a text message or a call request message and the like, sent from another electronic device, to the electronic device 100. The electronic device 101 may send a specific control signal to the electronic device 100 at a certain time in response to specific schedule information. For example, the electronic device 101 may send a control signal associated with controlling the display module 140 or audio data to be output through the input and output module 120 to the electronic device 100 at a certain time. Therefore, the user may recognize a state, where the electronic device 100 is not worn, at a certain time.

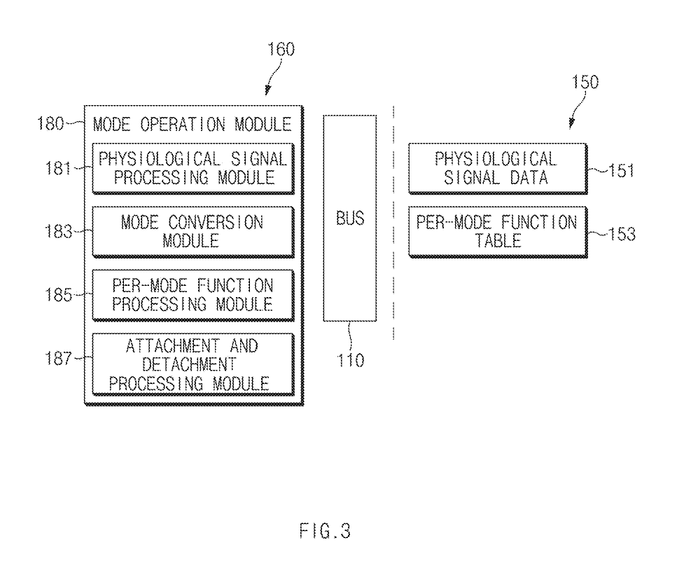

FIG. 3 is a block diagram illustrating a detailed configuration of a mode operation module and a detailed configuration of a storage module according to an embodiment of the present disclosure.

Referring to FIG. 3, a storage module 150 may include physiological signal data 151 and a per-mode function table 153.

The physiological signal data 151 may include reference information. The reference information may be used as criteria for comparing physiological signals. According to an embodiment, the reference information may include a reference physiological signal when an electronic device 100 of FIG. 2 is worn on an outer portion of a wrist of a user and a reference physiological signal when the electronic device 100 is worn on an inner portion of the wrist. Also, the reference information may include a reference physiological signal associated with an ankle, a finger, a neck, and the like of the user. According to various embodiments, the reference information may include a certain range value or a reference value. For example, the reference information may include a range value or a reference value of being determined as the electronic device 100 is worn on the outer portion of the wrist and a range value or a reference value of being determined as the electronic device 100 is worn on the inner portion of the wrist. The physiological signal data 151 may include a physiological signal currently collected by a sensor module 170 of FIG. 2. The physiological signal may include a PPG signal.

The per-mode function table 153 may be a table including a list of at least one function to be performed based on a state where the electronic device 100 is worn. For example, the per-mode function table 153 may include a wearing mode function table, a taking-off mode function table, and a loss mode function table. The wearing mode function table may include a function table for each worn portion. According to an embodiment, a form of a specific function item included in the wearing mode function table, executed for each worn portion, may be defined in a different way.

The mode operation module 180 may determine proximity information collected by an HRM sensor 171 of FIG. 1 and send information about a state where the electronic device 100 is worn or information about a state where the electronic device 100 is not worn (or information a state where the electronic device 100 is attached/detached) to the electronic device 100 or external electronic device 101 and 102 of FIG. 2, and the like. According to an embodiment, the mode operation module 180 may activate at least one of an acceleration sensor or a gyro sensor to automatically determine a sleeping state of the user. The mode operation module 180 may determine a sleep-in mode state or a sleep-out mode state based on analysis of collected acceleration sensor information, collected gyro sensor information, and a signal collected by the HRM sensor 171. The mode operation module 180 may perform a previously defined specific function or a specific operation of the electronic device 100 in response to the sleep-in mode state or the sleep-out mode state. According to an embodiment, the mode operation module 180 may collect physiological information, such as an amount of blood flow, blood pressure, and blood oxygen saturation (SpO₂), changed by a physical change of a portion, such as finger motion, finger tapping, first clenching/opening, and wrist motion, adjacent to the electronic device 100 using a corresponding sensor, for example, the HRM sensor 171. The mode operation module 180 may detect a signal of the collected physiological information and may execute a specific operation based on secondary information (e.g., one tap information, two tap information, N tap information, long tap information, and the like) as well as primary information (e.g., heartbeat information).

The above-mentioned mode operation module 180 may include a physiological signal processing module 181, a mode conversion module 183, a per-mode function processing module 185, and an attachment and detachment processing module 187.

The physiological signal processing module 181 may activate a sensor module 170 of FIG. 2 in response to specific schedule information or a specific signal such as an input signal received through an input and output module 120 of FIG. 2. The physiological signal processing module 181 may analyze a sensor signal sent from the sensor module 170. If a sensor signal is received from the sensor module 170, the physiological signal processing module 181 may verify reference information stored in a storage module 150 of FIG. 2 and may analyze whether electronic device 100 is worn and a portion where the electronic device 100 is worn. The physiological signal processing module 181 may send information about the worn state and information about the worn portion to the mode conversion module 183 and the per-mode function processing module 185.

According to various embodiments, the physiological signal processing module 181 may change a sensor period of the sensor module 170. For example, if it is determined that the electronic device 100 is worn, the physiological signal processing module 181 may change a sensor period of the sensor module 170 to be longer (or shorter) than a previous state. If it is determined that the electronic device 100 is taken off, the physiological signal processing module 181 may change a sensor period of the sensor module 170 to be more longer (or shorter) than a previous state or may inactivate the sensor module 170. The above-mentioned extension or reduction of the sensor period may be adjusted based on a change of a device design.

The physiological signal processing module 181 may support a training mode. For example, the physiological signal processing module 181 may output a guide message, for a portion where the electronic device 100 will be worn, through a display module 140 of FIG. 2 or the input and output module 120. The physiological signal processing module 181 may activate the sensor module 170 after outputting the guide message and may store collected physiological signal as reference information corresponding to the corresponding worn portion. The physiological signal processing module 181 may collect reference information about that the electronic device 100 is worn on an inner portion of a wrist of the user and reference information about that the electronic device 100 is worn on an outer portion of the wrist, through the performance of the above-mentioned operation. Also, the physiological signal processing module 181 may collect reference information about that the electronic device 100 is worn on a neck, an ankle, a finger, a lower arm, or an upper arm, and the like.

The mode conversion module 183 may receive the worn state information or the worn portion information from the physiological signal processing module 181. If receiving the worn state information, the mode conversion module 183 may verify information about a worn portion. If the worn portion is a first portion (e.g., an inner portion of the wrist), the mode conversion module 183 may convert a user interface (UI) of the display module 140 into a first UI mode (e.g., a landscape mode or a horizontal writing mode (or form or method)). If the worn portion is a second portion (e.g., an outer portion of the wrist), the mode conversion module 183 may convert the UI of the display module 140 into a second UI mode (e.g., a portrait mode of the horizontal writing mode (or form or method) or a vertical writing mode (or form or method)). According to various embodiments, if a current state is a state where the electronic device 100 is taken off, the mode conversion module 183 may convert a mode of the display module 140 into a sleep mode.

The per-mode function processing module 185 may process a defined function based on worn state information and worn portion information, sent from the physiological signal processing module 181. For example, the per-mode function processing module 185 may process a specific function based on information indicating whether the electronic device 100 is worn, information about a portion where the electronic device 100 is worn, and information about a state where the electronic device 100 is normally taken off.

According to an embodiment, when the electronic device 100 is maintained, the per-mode function processing module 185 may block power supplied to the sensor module 170 included in the electronic device 100 and may block power supplied to the display module 140. Alternatively, when the electronic device is maintained, the per-mode function processing module 185 may automatically convert a state of the electronic device 100 into a turned-off state. In this regard, after the electronic device 100 is normally taken off from the wrist, the per-mode function processing module 185 may control the HRM sensor 171 to detect a sensor signal. If the sensor signal has a specific signal format (e.g., a state whether there is no PPG signal and where a noise signal corresponding to certain illumination is detected), the per-mode function processing module 185 may determine that the electronic device 100 is kept.

According to an embodiment, if the electronic device 100 is in a charging state, the per-mode function processing module 185 may inactivate the other components except for a communication interface 130 of FIG. 2. If the charging of the electronic device 100 is completed, the per-mode function processing module 185 may change a mode of the electronic device 100 to a sleep mode or may change a state of the electronic device 100 to a turned-off state. If the charging state of the electronic device 100 is released, the per-mode function processing module 185 may automatically activate the sensor mode 170 and may detect whether the electronic device 100 is worn.

According to an embodiment, if the electronic device 100 is worn on a first or second portion (e.g., an inner or outer portion of the wrist), the per-mode function processing module 185 may process a function in a public mode. For example, when the public mode is performed, the per-mode function processing module 185 may output at least some of contents of a received message on the display module 140. Also, the per-mode function processing module 185 may output a message reception alarm. If the electronic device 100 is worn on the second or first portion (e.g., the outer or inner side of the wrist), the per-mode function processing module 185 may process a function in a privacy mode. For example, when the privacy mode is performed, the per-mode function processing module 185 may output only a display alarm or vibration alarm for a received message. The per-mode function processing module 185 may process another function based on a wearing form for an e-mail, a communication message, and the like.

The attachment and detachment processing module 187 may determine whether the electronic device 100 is lost and may prevent the electronic device 100 from being lost, using at least one of an illumination sensor or a proximity sensor. For example, if detection of a physiological signal (or a PPG signal) is stopped, the attachment and detachment processing module 187 may activate an acceleration sensor or a gyro sensor or may analyze a sensor signal provided from a previously activated acceleration sensor or gyro sensor. The attachment and detachment processing module 187 may determine a state where the electronic device 100 is spaced apart from a worn portion, based on the analyzed sensor signal. For example, if the electronic device 100 is spaced apart from a worn portion at certain acceleration at a certain distance or more, the attachment and detachment processing module 187 may determine that the electronic device 100 is taken off by loss. If the electronic device 100 is spaced apart from a worn portion within a certain distance and if acceleration or speed is irregularly changed, the attachment and detachment processing module 187 may determine that the electronic device 100 is taken off by loss.

According to various embodiments, if the electronic device 100 is taken off from a worn portion (e.g., detection of a PPG signal of the HRM sensor 171 is stopped), the attachment and detachment processing module 187 may process a sensor signal, collected by the HRM sensor, based on at least one of an illumination sensor processing scheme or a proximity sensor processing scheme. The attachment and detachment processing module 187 may determine, for example, at least one of a proximity change or an illumination change through a change of a sensor signal collected by the HRM sensor 171. If the at least one of the proximity change or the illumination change is a change corresponding to a specific taken-off state by loss, the attachment and detachment processing module 187 may determine that the loss of the electronic device 100 is taken off by loss.

If determining that the electronic device 100 is taken off by loss, the attachment and detachment processing module 187 may send a specific message to the electronic device 101 or the electronic device 102. If determining that the electronic device 100 is taken off by loss, the attachment and detachment processing module 187 may output specific data through at least one of a vibration module, the display module 140, or the input and output module 120 of the electronic device 100.

According to various embodiments, an electronic device may include a sensor module configured to collect a signal, a module configured to generate physiological information based on at least part of the collected signal, a module configured to generate proximity information based on at least part of the collected signal, a module configured to generate illumination information based on at least part of the collected signal, and a module configured to determine a state of the electronic device based on at least part of the physiological information, the proximity information, or the illumination information.

According to various embodiments, the physiological information may be a heart rate.

According to various embodiments, the state of the electronic device may include a state where the electronic device is worn.

According to various embodiments, the electronic device may further include a control module configured to control the electronic device using at least one of the physiological information, the proximity information, or the illumination information.

According to various embodiments, the control module may determine a portion where the electronic device is worn, based on at least one of a frequency domain characteristic or a time domain characteristic of a physiological signal.

According to various embodiments, the control module may determine whether the electronic device is worn, based on analysis of the proximity information and may determine a portion whether the electronic device is worn, based on analysis of a physiological signal when the electronic device is worn.

According to various embodiments, the electronic device may further include a storage module configured to store a physiological signal for each specific portion as reference information in a state where the electronic device is worn on a specific portion of a wearer.

According to various embodiments, the control module may determine a worn state and a worn portion by comparing similarity between the reference information and collected information.

According to various embodiments, the control module may output information of the electronic device in a different form in response to the worn state.

According to various embodiments, the control module may output the information in at least one of a landscape arrangement horizontal writing mode (or form, or method), a landscape arrangement vertical writing mode, a portrait arrangement horizontal writing mode, a portrait arrangement vertical writing mode, an inverted mode, a mode of changing an output location of a soft button associated with executing a specific function in response to the worn state, or a mode of changing an execution function type of a soft button output on a display module in response to the worn state, in response to the worn state.

According to various embodiments, the control module may process a function of the electronic device in a different way in response to the worn state.

According to various embodiments, the control module may provide notification that an event of the electronic device is generated in response to the worn state and may output at least part of information about contents of the generated event of the electronic device in response to the worn state.

According to various embodiments, the control module may verify authentication when the electronic device is not worn.

According to various embodiments, an electronic device may include a sensor module configured to collect physiological signal and a control module configured to determine a worn state based on at least one of information in which a physiological signal of a sensor signal collected by the sensor module is analyzed, proximity information analyzed based on the sensor signal, or illumination information analyzed based on the sensor signal.

According to various embodiments, the control module may determine the proximity information and may output information about a state where the electronic device is worn or a state where the electronic device is not worn (or state where the electronic device is attached or detached) through the electronic device or an external electronic device.

According to various embodiments, the control module may automatically determine whether a user of the electronic device enters a sleeping state, based on physiological information, acceleration information, and gyro information.

According to various embodiments, the control module may detect physical information through the electronic device and may perform a specific operation of at least one of the electronic device or an external electronic device. According to various embodiments, the control module may detect changed physiological information of at least one of an amount of blood flow, blood pressure, or blood oxygen saturation changed in response to a physical change of a portion where the electronic device is worn and may perform a specific operation of the electronic device based on a physical operation inferred based on the physiological information and the physical change.

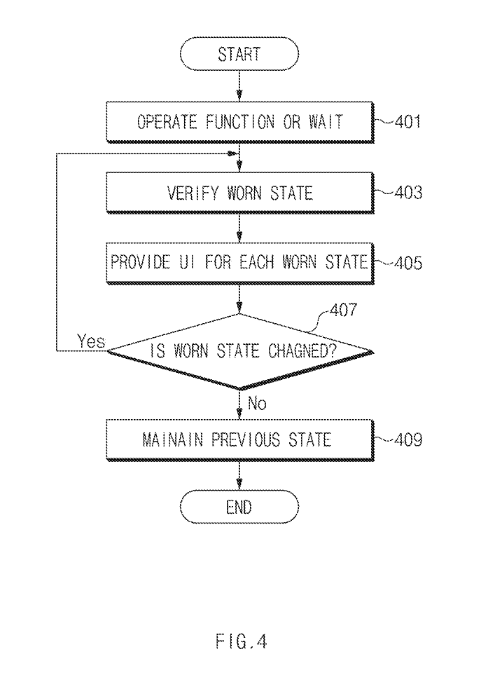

FIG. 4 is a flowchart illustrating a UI operation method of an electronic device for each worn state according to an embodiment of the present disclosure.

Referring to FIG. 4, in operation 401 of the electronic device UI operation method for each worn state, a control module 160 of FIG. 2 may operate a function or may wait. For example, the control module 160 may operate an electronic device 100 of FIG. 2 in a low power mode or in a sleep mode. Herein, the low power mode or the sleep mode may be a mode of blocking power supplied to a display module 140 of FIG. 2 and maintaining only power of a specific component. For example, the control module 160 may supply power to an HRM sensor 171 of FIG. 2 and may block power supplied to other components (e.g., the display module 140, a communication interface 130 of FIG. 2, and the like). According to an embodiment, in operation 401, the control module 160 may control power supply of the electronic device 100 and may perform an initialization process in response to reception of an input signal for turning on the electronic device 100. According to an embodiment, in operation 401, the control module 160 may output audio data in response to a specific function of the electronic device 100, for example, a sound source play function.

In operation 403, the control module 160 may verify a state where the electronic device 100 is worn. For example, the control module 160 may determine whether a physiological signal is included in a sensor signal collected by an HRM sensor 171 of FIG. 2. If a sensor signal which does not include the physiological signal is received, the control module 160 may determine that the electronic device 100 is not worn. If determining that the sensor signal includes the physiological signal, the control module 160 may determine that the electronic device 100 is worn on a certain portion of a user of the electronic device 100. According to various embodiments, the control module 160 may determine a portion where the electronic device 100 is worn, based on a characteristic of the collected physiological signal. For example, if the collected physiological signal corresponds to specific first reference information, the control module 160 may determine that the electronic device 100 is worn on an inner portion of a wrist of the user. If the collected physiological signal corresponds to specific second reference information, the control module 160 may determine that the electronic device 100 is worn on an outer portion of the wrist. According to various embodiments, the control module 160 may determine a state where the electronic device 100 is worn on a specific portion, for example, a finger, an ankle, a neck, an upper arm, or a lower arm by comparing previously defined reference information with a currently collected sensor signal. In this regard, the control module 160 may obtain reference information for each portion through a training mode.

In operation 405, the control module 160 may provide a UI for each worn state. For example, the control module 160 may provide a UI based on a state where the electronic device 100 is not worn and a UI based on a state where the electronic device 100 is worn. The UI based on the state where the electronic device 100 is not worn may include, for example, a UI of a turned-off state or a lock screen state. The UI based on the state where the electronic device 100 is worn may differ for each worn portion. For example, the UI based on the state where the electronic device 100 is worn may include a landscape mode UI provided when the electronic device 100 is worn on an inner portion of the wrist and a portrait mode UI provided when the electronic device 100 is worn on an outer portion of the wrist.

In operation 407, the control module 160 may determine whether the worn state is changed. In connection with determining whether the worn state is changed, the control module 160 may activate the HRM sensor 171 at a certain period and may determine whether the worn state is changed. Alternatively, the control module 160 may operate the HRM sensor 171 in real time and may determine whether the worn state is changed. If the worn state is not changed in operation 407, the control module 160 may branch to operation 409 and may maintain a previous state. While maintaining the previous state, the control module 160 may perform operation 407 of determining whether the worn state is changed. Also, the control module 160 may end the function if an event associated with ending the function of the electronic device 100 is generated, while maintaining the previous state. If the worn state is changed in operation 407, the control module 160 may branch to operation 403 and may perform the operation again from operation 403.

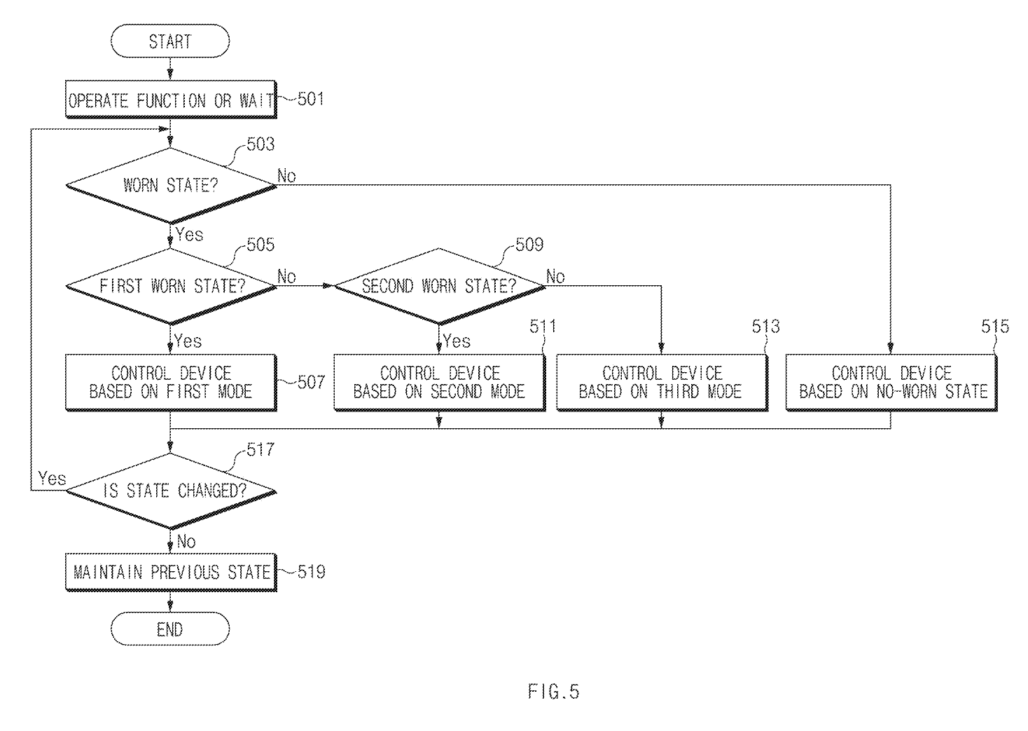

FIG. 5 is a flowchart illustrating an electronic device operation method for each worn state according to an embodiment of the present disclosure.

Referring to FIG. 5, in operation 501 of the electronic device operation method for each worn state, a control module 160 of FIG. 2 may operate a function or may wait. The control module 160 may perform a specific function, for example, a waiting screen output function, a menu screen output function, a lock screen function, and the like, based on specific schedule information. Alternatively, the control module 160 may keep an HRM sensor 171 of a sensor module 170 of FIG. 2 a sleep mode state (e.g., a state of maintaining only power supply and blocking power supplied to other components).

In operation 503, the control module 160 may determine whether an electronic device of FIG. 2 is in a worn state. The control module 160 may determine whether the electronic device 100 is in the worn state, relative to a sensor signal sent from the HRM sensor 171. If determining that the electronic device 100 is in the worn state in operation 503, in operation 505, the control module 160 may determine whether the electronic device 100 is in a first worn state (e.g., a state where the electronic device 100 is worn on an inner portion of a wrist of a user). If the electronic device 100 is in the first worn state in operation 505, in operation 507, the control module 160 may perform device control based on a first mode. According to an embodiment, the control module 160 may output all or part of information associated with performing a specific function. For example, when a message is received, the control module 160 may output all or some of contents of the received message. According to an embodiment, if the electronic device 100 in the first worn state, the control module 160 may operate a non-security mode. For example, the control module 160 may enter a menu or may display information, without performing a separate authentication process upon operating the electronic device 100.

If the electronic device 100 is not in the first worn state in operation 505, in operation 509, the control module 160 may determine whether the electronic device 100 is in a second worn state (e.g., a state where the electronic device 100 is worn on an outer portion of the wrist). If determining that the electronic device 100 is in the second worn state in operation 509, in operation 511, the control module 160 may perform device control based on a second mode. According to an embodiment, the control module 160 may output notification of information to be output in connection with performing a specific function. For example, when a message is received, the control module 160 may output notification that the message is received. According to an embodiment, if the electronic device 100 is in the second worn state, the control module 160 may operate a security mode. For example, the control module 160 may enter a menu or may display information through an authentication process upon operating the electronic device 100. In this regard, the control module 160 may output an input window for entering authentication information and may verify the entered authentication information.

If the electronic device 100 is not in the second worn state in operation 509, in operation 513, the control module 160 may perform device control based on a third mode. For example, if the electronic device 100 is worn on an upper arm of the user, the control module 160 may change information associated with performing a function to a TTS and may output the changed—(TTX). For example, when a message is received, the control module 160 may convert contents of the message into a TTX and may output the converted TTX.

If the electronic device 100 is not in the worn state in operation 503, in operation 515, the control module 160 may perform device control based on a state where the electronic device 100 is not worn. For example, the control module 160 may power off the display module 140 and may perform a specific function, for example, a sound source play function. In this operation, the control module 160 may reduce power consumption by adjusting a sensor period of the HRM sensor 171 to be longer than the worn state.

In operation 517, the control module 160 may determine whether the worn state is changed. If the worn state is changed in operation 517, the control module 160 may branch to operation 503 and may perform the operation again from operation 503. If the worn state is not changed in operation 517, in operation 519, the control module 160 may maintain a previous state. While maintaining the previous state, the control module 160 may perform operation 517 again. When the worn state is changed, the control module 160 may change a function based on the change of the worn state.

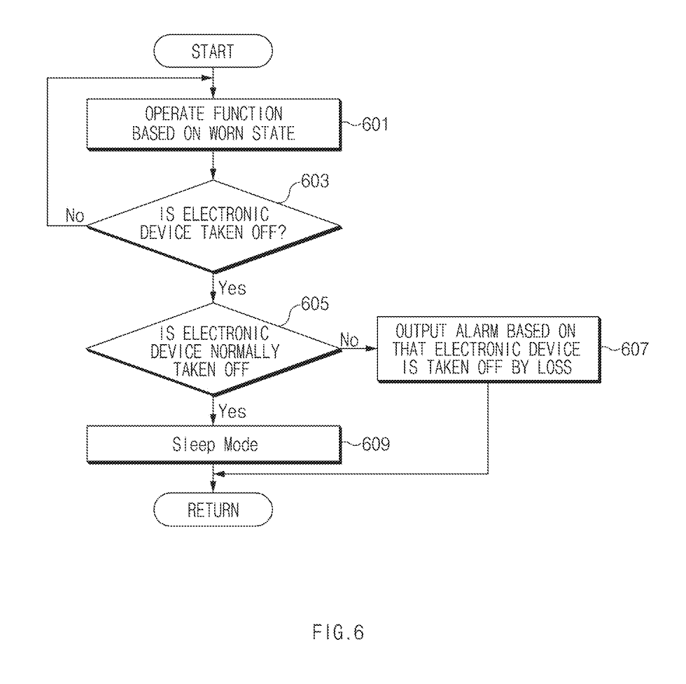

FIG. 6 is a flowchart illustrating an electronic device operation method associated with loss prevention according to an embodiment of the present disclosure.

Referring to FIG. 6, in operation 601 of the electronic device operation method associated with loss prevention, a control module 160 of FIG. 2 may operate a function based on a state where an electronic device 100 of FIG. 2 is worn. For example, the control module 160 may check a physical condition of a wearer by analyzing a physiological signal provided from an HRM sensor 171 of FIG. 2. Alternatively, the control module 160 may maintain a state of supporting a communication waiting function and a relay function, such as notification that a communication message is received. Alternatively, the control module 160 may support a pedometer function or a clock display function in response to scheduled information.

In operation 603, the control module 160 may determine whether the electronic device 100 is taken off. In this regard, the control module 160 may determine whether a sensor signal of the HRM sensor 171 is changed. If the sensor signal of the HRM sensor 171 is changed, the control module 160 may determine that an even associated with a state where the electronic device 100 is taken off is generated. If the sensor signal of the HRM sensor 171 is not changed, the control module 160 may branch to operation 601 and may perform the operation again from operation 601.

If the electronic device 100 is taken off in operation 603, in operation 605, the control module 160 may determine whether the electronic device is normally taken off. In this regard, the control module 160 may store and operation at least one of a change value of a sensor signal associated with a state where the electronic device 100 is normally taken off or a change value of a sensor signal associated with a state where the electronic device 100 is abnormally taken off. A storage module 150 of FIG. 2 may store reference information associated with the state where the electronic device 100 is normally taken off and reference information associated with the state where the electronic device 100 is abnormally taken off. The storage module 150 may provide the reference information in response to a request of the control module 160. The control module 160 may collect the reference information associated with the state where the electronic device 100 is normally taken off and the reference information associated with the state where the electronic device 100 is abnormally taken off, through a training mode or history of using the electronic device.

If determining that the electronic device 100 is not normally taken off in operation 605, in operation 607, the control module 160 may output an alarm based on a state where the electronic device 100 is taken off by loss. The control module 160 may output a beep sound or specific audio data through an input and output module 120 of FIG. 2. The control module 160 may change a state where a display module 140 of FIG. 2 is turned on or off to a specific state where the electronic device 100 is taken off by loss. The control module 160 may change a current mode of the electronic device 100 to a guest mode and may perform an authentication process in advance when a control request is received. According to various embodiments, when the electronic device 100 is taken off by loss, the control module 160 may control a communication interface 130 of FIG. 2 to send a loss alarm message to a specific electronic device 101 or 102 of FIG. 2.

According to an embodiment, if a change of a sensor signal provided from the HRM sensor 171 corresponds to the reference information associated with the state where the electronic device 100 is abnormally taken off, the control module 160 may determine that the electronic device 100 is taken off by loss. In this operation, if a sensor signal of the HRM sensor 171 is changed, the control module 160 may change a sensor signal collected by the HRM sensor 171 to at least one of an illumination sensor signal or a proximity sensor signal and may determine at least one of an illumination change or a proximity distance change based on the changed result. If the at least one of the illumination change or the proximity distance change is similar to previously defined (or specific) reference information associated with a state where the electronic device 100 is abnormally taken off, the control module 160 may determine that the electronic device 100 is abnormally taken off. Also, If the at least one of the illumination change or the proximity distance change is similar to previously defined reference information associated with a state where the electronic device 100 is normally taken off, the control module 160 may determine that the electronic device 100 is normally taken off. According to various embodiments, the control module 160 may use only the reference information associated with the state where the electronic device 100 is normally taken off or only the reference information associated with the state where the electronic device 100 is abnormally taken off. For example, if a sensor signal does not correspond to the reference information associated with the state where the electronic device 100 is normally taken off, the control module 160 may determine that the electronic device 100 is abnormally taken off. Alternatively, if a sensor signal does not correspond to the reference information associated with the state where the electronic device 100 is abnormally taken off, the control module 160 may determine that the electronic device 100 is normally taken off.

If determining that the electronic device 100 is normally taken off in operation 605, in operation 609, the control module 160 may perform a function based on the state where the electronic device 100 is normally taken off, for example, may enter a sleep mode. The sleep mode may be a mode of blocking power supplied to the display module 140. The sleep mode may be a mode of lengthening an operation period of the sensor module 170.

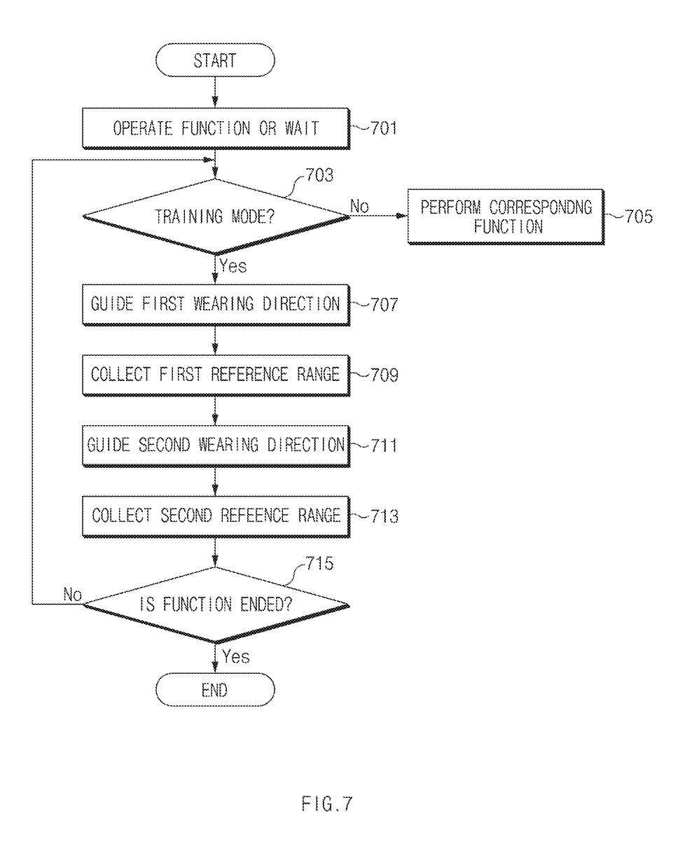

FIG. 7 is a flowchart illustrating an electronic device operation method associated with a training mode according to an embodiment of the present disclosure.

Referring to FIG. 7, in operation 701 of the electronic device operation method associated with the training mode, a control module 160 of FIG. 2 may operate its function and may wait. According to an embodiment, the control module 160 may output an object, an icon, an item, or a menu item associated with executing at least one function or application supported by an electronic device 100 of FIG. 2. For example, the control module 160 may output an object associated with executing a training mode function (e.g., a function of collecting reference information for each state where the electronic device 100 is worn).

In operation 703, the control module 160 may determine whether an event associated with executing the training mode is generated. For example, the control module 160 may determine whether an event for selecting the object associated with the training mode function is generated. Alternatively, the control module 160 may verify a scheduling event to automatically activate the training mode if the electronic device 100 receives initial power. Alternatively, the control module 160 may determine whether a message associated with entering the training mode is received from another electronic device (e.g., an electronic device 101 or 102 of FIG. 2),

If the event which is not associated with executing the training module is generated in operation 703, in operation 705, the control module 160 may perform a corresponding function corresponding to a type of the generated event. For example, the control module 160 may perform a sound source play function, a health coaching function (e.g., a pedometer function, a function of providing cardiovascular state information, and the like), a function of being changed to a sleep mode (e.g., a state where a display module 140 of FIG. 2 is turned off), in response to the type of the generated event.

If the event associated with executing the training mode is generated in operation 703, in operation 707, the control module 160 may guide a first wearing direction. For example, the control module 160 may output guide information (e.g., arrow information and the like) for guiding a user of the electronic device 100 to wear the electronic device 100 on at least one of a left wrist, a left ankle, a left finger, a left upper arm, a left lower arm, or a neck of the user and guiding a direction inserted into a corresponding worn portion. In operation 709, the control module 160 may collect a first reference range.

For example, the control module 160 may collect physiological signal information (e.g., at least one PPG signal, bloodstream flow information of a blood vessel of the user, and the like) in a state where the electronic device 100 is worn on a left specific portion of a body of the user. The control module 160 may generate reference information corresponding to the first reference range in the state where the electronic device 100 is worn on the specific portion, relative to the collected physiological signal information. If collecting physiological signal information of the first reference range which may be used as the reference information, the control module 160 may guide the first wearing direction and may guide the completion of the first reference range collection process.

In operation 711, the control module 160 may guide a second wearing direction. For example, the control module 160 may output guide information (e.g., arrow information and the like) for guiding the user to wear the electronic device 100 on at least one of a right wrist, a right ankle, a right finger, a right upper arm, or a right lower arm of the user and guiding a direction inserted into the corresponding worn portion. In operation 713, the control module 160 may collect a second reference range. The control module 160 may generate reference information about a specific worn portion and a specific wearing direction based on the second reference range.

In operation 715, the control module 160 may determine whether an event associated with ending the function is generated. If the event associated with ending the function is not generated in operation 715, the control module 160 may branch to operation 703 and may perform the operation again from operation 703. If the event associated with ending the function is generated in operation 715, the control module 160 may stop the training mode function.

According to various embodiments, the control module 160 may collect and store reference information about a state where the electronic device 100 is not worn and reference information about a clip mode state, in a training mode process. For example, after outputting guide information about the state where the electronic device 100 is not worn in the training mode process, the control module 160 may collect a sensor signal using an HRM sensor 171 of FIG. 2 during a certain time. In this operation, the control module 160 may collect the reference information about the state where the electronic device 100 is not worn (e.g., information corresponding to the state that there is no physiological signal by the HRM sensor 171 and the state where there is no proximity object based on analysis of a sensor signal of the HRM sensor 171). The control module 160 may collect the reference information about the clip mode state (e.g., information corresponding to the state that there is no physiological signal by the HRM sensor 171 and the state where there is a proximity object based on analysis of a sensor signal of the HRM sensor 171).

According to various embodiments, a method for operating an electronic device may include collecting a signal based on a sensor module and determining a state of the electronic device based on at least one of physiological information based on at least part of the collected signal, proximity information based on the at least part of the collected signal, or illumination information based on the at least part of the collected signal.

According to various embodiments, the physiological information may be a heart rate.

According to various embodiments, the state of the electronic device may include a state where the electronic device is worn.

According to various embodiments, the method may further include controlling the electronic device using at least one of the physiological information, the proximity information, or the illumination information.

According to various embodiments, the determining of the state of the electronic device may include determining a portion where the electronic device is worn, based on at least one of a frequency domain characteristic or a time domain characteristic of a physiological signal.

According to various embodiments, the determining of the state of the electronic device may include determining whether the electronic device is worn, based on analysis of the proximity information and determining a portion whether the electronic device is worn, based on analysis of a physiological signal.

According to various embodiments, the method may further include collecting a physiological signal in a state where the electronic device is worn on a specific portion of a wearer of the electronic device and storing the physiological signal for each specific portion as reference information.

According to various embodiments, the determining of the state of the electronic device may include determining a worn state and a worn portion by comparing similarity between the reference information and collected information.

According to various embodiments, the method may further include outputting information of the electronic device in a different form in response to the worn state.

According to various embodiments, the outputting of the information of the electronic device may include at least one of outputting the information in a landscape arrangement horizontal writing mode in response to the worn state, outputting the information in a landscape arrangement vertical writing mode (or form, or method) in response to the worn state, outputting the information in a portrait arrangement horizontal writing mode in response to the worn state, outputting the information in a portrait arrangement vertical writing mode in response to the worn state, outputting the information in an inverted mode in response to the worn state, changing an output location of a soft button associated with executing a specific function in response to the worn state, or changing an execution function type of a soft button output on a display module in response to the worn state.

According to various embodiments, the method may further include processing a function of the electronic device in a different way in response to the worn state.

According to various embodiments, the processing of the function of the electronic device may include at least one of providing notification that an event of the electronic device is generated in response to the worn state or outputting at least part of information about contents of the generated event of the electronic device in response to the worn state.

According to various embodiments, the processing of the function of the electronic device may include verifying authentication when the electronic device is not worn.

According to various embodiments, a method for operating an electronic device may include collecting a sensor signal of a specific sensor and determining a state where the electronic device including the sensor is worn, based on at least one of information in which a physiological signal of the collected sensor signal is analyzed, proximity information analyzed based on the sensor signal, or illumination information analyzed based on the sensor signal.

According to various embodiments, the determining of the state where the electronic device is worn may include determining the proximity information and outputting information about a state where the electronic device is worn or a state where the electronic device 100 is not worn, through the electronic device or an external electronic device, automatically determining whether a user of the electronic device enters a sleeping state, based on physiological information, acceleration information, and gyro information, or detecting physical information through the electronic device and performing a specific operation of at least one of the electronic device or the external electronic device.

According to various embodiments, the determining of the state where the electronic device is worn may include detecting changed physiological information of at least one of an amount of blood flow, blood pressure, or blood oxygen saturation changed in response to a physical change of a portion where the electronic device is worn and performing a specific operation of the electronic device based on a physical operation inferred based on the physiological information and the physical change.

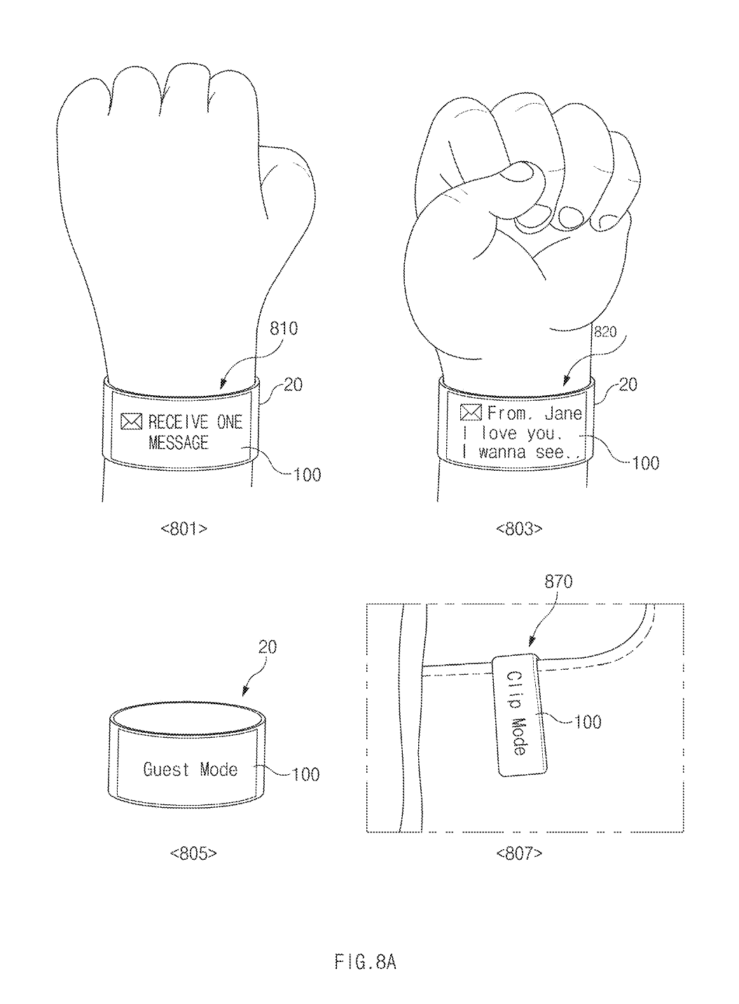

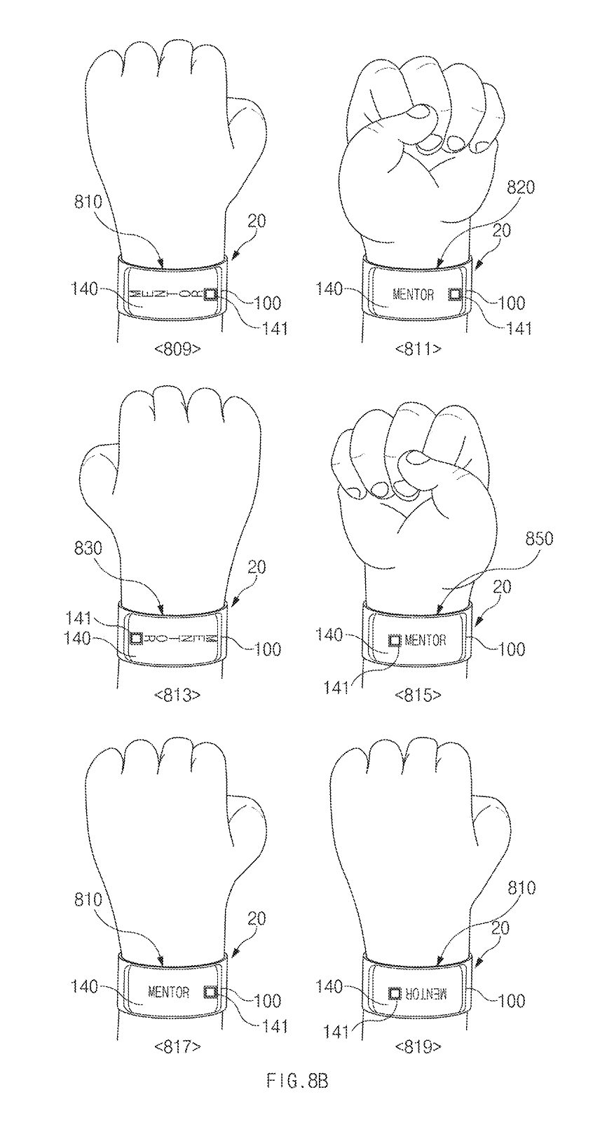

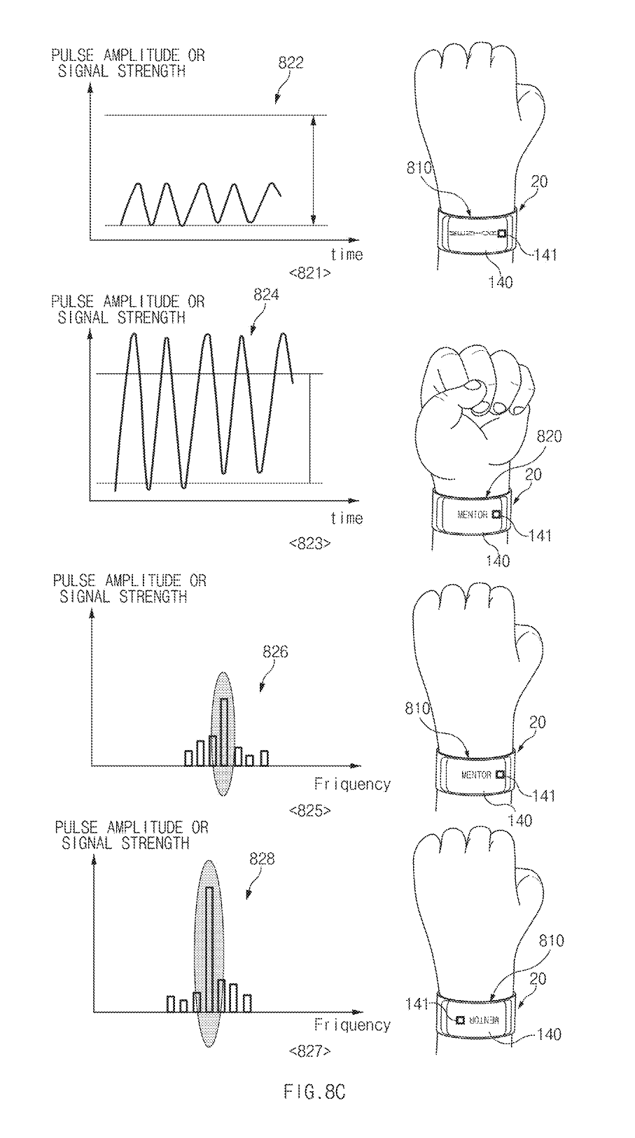

FIG. 8A is a drawing illustrating a mode control based on a state where an electronic device is worn according to an embodiment of the present disclosure.

Referring to FIG. 8A, in state 801, an electronic module 20 may be worn to arrange an electronic device 100 on an outer portion 810 of a left wrist of a user of the electronic device 100. An HRM sensor 171 disposed in the electronic device 100 may be disposed on the outer portion 810 of the left wrist of the user to detect a sensor signal. A control module 160 of the electronic device 100 may analyze a sensor signal sent from the HRM sensor 171 and may determine whether the analyzed sensor signal is a physiological signal of any format. For example, the control module 160 may determine that the electronic device 100 is disposed on the outer portion 810 of the left wrist, based on previously stored reference information associated with the outer portion 810 of the left wrist. Information in which a physiological signal is measured on the outer portion 810 of the left wrist may be different from information in which a physiological signal is measured on an inner portion 820 of the left wrist. Also, information in which a physiological signal is measured in the right hand of the user may be different from information in which a physiological signal is measured in the left hand of the user. The reference information may include information about feature points extracted from physiological signal measurement information having different characteristics for each portion.

If determining that the electronic device 100 is disposed on the outer portion 810 of the left wrist, the control module 160 may output information in a privacy mode (e.g., an alarm or a guide information output function or mode for information about a type of a generated event). For example, if a communication message is received, the control module 160 may output only notification that the communication message is received on a display module 140 of FIG. 2.

In state 803, the electronic device 20 may be worn to arrange the electronic device 100 on the inner portion 820 of the left wrist. The HRM sensor 171 disposed in the electronic device 100 may be disposed on the inner portion 820 of the left wrist to detect a sensor signal. The control module 160 may determine that the electronic device 100 is disposed on the inner portion 820 of the left wrist, using reference information stored in a storage module 150 of FIG. 2. If determining that the electronic device 100 is disposed on the inner portion 820 of the left wrist, the control module 160 may output information in a public mode (e.g., a function or mode of outputting at least part some of contents of an event). For example, if a communication message is received, the control module 160 may output at least some of contents of the message on the display module 140.

In state 805, the electronic module 20 may be powered on in a state where the electronic module 20 is not worn on a portion of a body of the user. Alternatively, the electronic device 20 may be in state 805 based on a state where it is taken off after it is worn on the portion of the body of the user. The control module 160 may analyze a sensor signal collected by the HRM sensor 171 and may determine whether a physiological signal is included in the analyzed sensor signal. In state 805, the control module 160 may verify a sensor signal which does not include the physiological signal. The control module 160 may be configured to operate the electronic device 100 of state 805 in a guest mode (e.g., a function or mode of not outputting an alarm or guide information for occurrence of an event). For example, if an input even is received from an input and output module 120 of FIG. 2, if a communication message is received, if a schedule arrives, or if an event occurs based on execution of a specific application, the control module 160 may perform an authentication information verification process. In this regard, the control module 160 may output an authentication information verification screen on the display module 140. If the authentication information verification process is completed, the control module 160 may output contents associated with the generated event through at least one of the display module 140 or the input and output module 120. According to various embodiments, if the HRM sensor 171 fails to perform biometric recognition or biometric authentication, the control module 160 may perform at least one of a specific simple message output or a notification screen output limit. After performing at least one of biometric recognition, biometric authentication, or password authentication, the control module 160 may be configured to operate in one of the public mode and the privacy mode.

In state 807, the electronic device 100 may be spaced apart from the electronic device 20 and may be mounted on a specific location. For example, the electronic device 100 may be arranged or mounted on a pocket of the user or a specific location 870 (e.g., a location which is not direct contact with a body of the user). The control module 160 may analyze a sensor signal collected from the HRM sensor 171. If the analyzed sensor signal does not include a physiological signal, the control module 160 may analyze proximity for the collected sensor signal. If the proximity is less than or equal to a specific value, the control module 160 may be configured to operate in a clip mode (e.g., a mode or function of performing a specific function such as a pedometer or headset function).

FIG. 8B is a drawing illustrating a UI control based on a state where an electronic device is worn according to an embodiment of the present disclosure.

Referring to FIG. 8B, an electronic module 20 may be worn on various portions of its user. For example, the electronic module 20 may have one of a state, such as state 809, where it is worn on an outer portion 810 of a left wrist of the user, a state, such as state 811, where it is worn on an inner portion 820 of the left wrist of the user, a state, such as state 813, where it is worn on an outer portion 830 of a right wrist of the user, and a state, such as state 815, where it is worn on an inner portion 850 of the right wrist of the user. Also, the electronic device 20 may be worn in an upper direction, in which one side of a display module 140 of an electronic device 100 is disposed to fingers of the user, in state 817 in a process where it is worn on the left or right hand of the user or may be worn in a lower direction, in which one side of the display module 140 is disposed to an inner side of an arm of the user, in state 819 in the process where it is worn on the left or right hand of the user.

According to an embodiment, a control module 160 of the electronic device 100 may provide various UI modes in response to a location where the electronic device 100 is worn. For example, if the electronic device 100 is in a state, such as state 809, where the electronic device 100 is worn on the outer portion 810 of the left wrist of the user, the control module 160 may output information of a vertical writing form, displayed from a left side to a right side, on the display module 140. According to an embodiment, if the electronic device 100 is in a state, such as state 811, where the electronic device 100 is worn on the inner portion 820 of the left wrist of the user, the control module 160 may output information of a horizontal writing form, displayed from the left side to the right side, on the display module 140. According to an embodiment, if the electronic device 100 is in a state, such as state 813, where the electronic device 100 is worn on the outer portion 830 of the right wrist of the user, the control module 160 may output information of a vertical writing form, displayed from the right side to the left side, on the display module 140. According to an embodiment, if the electronic device 100 is in a state, such as state 815, where the electronic device 100 is worn on the inner portion 850 of the right wrist of the user, the control module 160 may output information of a horizontal writing form, displayed from the left side to the right side, on the display module 140. According to an embodiment, if the electronic device 100 is in a state, such as state 817, where one side of the display module 140 is disposed to an upper side and where the electronic device 100 is worn on the outer portion 810 of the left wrist of the user, the control module 160 may output information of a horizontal writing form, displayed from a left side to a right side, on the display module 140. According to an embodiment, if the electronic device 100 is in a state, such as state 819, where one side of the display module 140 is disposed to a lower side and where the electronic device 100 is worn on the outer portion 810 of the left wrist of the user, the control module 160 may output information, displayed from the left side to the right side, which has a horizontal writing form and is inverted, on the display module 140.

Meanwhile, according to various embodiments, a UI mode of the electronic device 100 may be set or a setting of the UI mode may be changed, in response to a user input in a training mode. For example, the control module 160 may collect information about a UI output direction in a process of collecting reference information about a worn state in the training mode. In this regard, when providing a screen interface associated with the training mode, the control module 160 may provide a screen interface associated with a UI output direction. Alternatively, the control module 160 may output a screen interface associated with a UI output state, a UI output direction, and the like based on a specific state where the electronic device 100 is worn, a state where the electronic device 100 is not worn, or a portion where the electronic device 100 is worn. Therefore, the user may set the UI output state or the UI output direction based on the screen interface.

According to various embodiments, the control module 160 of the electronic device 100 may verify a sleeping state using a sensor signal collected by an HRM sensor 171 of FIG. 2. For example, the control module 160 may check whether the electronic device 100 is worn, at intervals of a previously defined certain time (e.g., for one second every five minutes) during a time except for a charging time. In this operation, the control module 160 may check only proximity based on a sensor signal collected by the HRM sensor 171, may analyze a physiological signal based on whether the electronic device 100 is close to a specific portion of a body of the user, and may check at least one of whether the electronic device 100 is worn or whether the user is in the sleeping state. The control module 160 may store and manage a physiological signal for the sleeping state as reference information.

According to various embodiments, the control module 160 may determine whether the user is in the sleeping state by checking proximity and an acceleration sensor signal. In this operation, the control module 160 may send a sensor signal collected by the HRM sensor 171, as a proximity sensor signal of determining whether the electronic device 100 is worn, to another electronic device 101 or 102 of FIG. 2 based on an RSF. If a wearer is in a sleep mode, the control module 160 may employ a UI mode (e.g., a sleep mode where the display module 140 is turned off) corresponding to the sleep mode.

According to various embodiments, the control module 160 may analyze signals collected by a gyro sensor, an acceleration sensor, and the HRM sensor 171 and may automatically determine whether the user in the sleeping state. If determining that the user is in the sleeping state, the control module 160 may be configured to perform a specific function of the electronic device 100, for example, at least one of a sleep entering mode and a sleep release mode. The sleep entering mode may be, for example, a mode of turning off the display module 140 or changing a current state to a deep sleep mode entering state of the electronic device 100. The sleep release mode may be a mode of performing a previously defined specific function, for example, a mode including at least one of a function of automatically outputting a clock function, a function of automatically collecting and outputting weather information, or a function of automatically executing a set sound source.

According to various embodiments, the display module 140 of the electronic device 100 may include a soft button 141. The soft button 141 may provide a short-cut function (e.g., a healthcare function) which immediately enters a specific function of the electronic device 100 or may provide a specific menu. Alternatively, the soft button 141 may provide a function of searching for a received and stored message or specific data stored in a storage module 150 of FIG. 2, based on a setting. Alternatively, the soft button 141 may support an automatic synchronization function (e.g., a BT auto pairing function and the like) with an external device. A location of the above-mentioned soft button 141 may be changed based on the above-mentioned worn state. According to an embodiment, the soft button 141 may be disposed, a display position of which is biased to a left side or a right side on the center of the display module 140 based on a state where the electronic device 100 is worn on the left hand of the user and a state where the electronic device 100 is worn on the right hand of the user. According to an embodiment, a location of the soft button 141, displayed on the display module 140, may be changed based on the state whether the electronic device 100 is worn on the outer portion of the wrist of the user and the state where the electronic device is worn on the inner portion of the wrist of the user.

According to various embodiments, the control module 160 may change a function, executed by the soft button 141, based on a state where the electronic device 100 is worn. For example, if the soft button 141 is selected in the state where the electronic device 100 is worn on the outer portion of the left wrist of the user, the control module 160 may be configured to basically execute a first function (e.g., a clock display function). Also, if the soft button 141 is selected in the state where the electronic device 100 is worn on the inner portion of the left wrist of the user, the control module 160 may be configured to basically execute a second function (e.g., a message search function). Also, if the soft button 141 is selected in the state where the electronic device 100 is worn on the inner portion of the right wrist of the user, the control module 160 may be configured to basically execute a third function (e.g., a menu output function). If the soft button 141 is additionally selected in a state while the first or second function is executed, the control module 160 may be configured to convert a menu function.

According to various embodiments, a function of the soft button 141, executed based on a change of a location, may be set in a different way. For example, if the soft button 141 is disposed in a first location of the display module 140 (e.g., a location within a certain distance from a left edge in a state where the display module 140 is placed in a transverse direction) and is selected, the control module 160 may execute the first function (e.g., a menu output function and the like). Alternatively, if the soft button 141 is disposed in a second location of the display module 140 (e.g., a location within a certain distance from a right edge in a state where the display module 140 is placed in the transverse direction or a central location, and the like) and is selected, the control module 160 may execute the second function (e.g., a healthcare function, a message search function, a clock function, and the like).

FIG. 8C is a drawing illustrating a mode control based on a state where an electronic device is worn, according to an embodiment of the present disclosure.

Referring to FIG. 8C, a control module 160 of FIG. 2 may analyze a sensor signal, collected by an HRM sensor 171 of FIG. 2, in time series. For example, control module 160 may analyze peak amplitude and a peak-to-peak interval (PPI) of a signal in a time domain and may determine whether an electronic device 100 of FIG. 2 is worn and a portion where the electronic device 100 is worn. The control module 160 may analyze at least one of a primary component frequency, amplitude (e.g., power spectrum density) of the primary component frequency, amplitude of an ambient component frequency, or the ratio of the primary component frequency to the ambient component frequency and may determine at least one of a worn state and a worn portion based on a collected signal. In this operation, the control module 160 may perform inter-signal classification using the amplitude of the primary or ambient component frequency or the ratio of the primary component frequency to the ambient component frequency, or may perform signal classification by comparing similarity between reference information and stored reference information. According to an embodiment, the control module 160 may classify a difference of a PPG signal based on a worn location (e.g., the left hand, the right hand, an inner or outer portion of a wrist, an upper or lower portion of the wrist, and the like) based on a difference of an amount of blood distribution. Also, the control module 160 may analyze a signal using a signal to noise ratio (SNR) (e.g., a percentage occupied by a primary component) by adherency when an electronic module 20 of FIG. 1 is close to a wrist of a user of the electronic module 20.

According to an embodiment, in state 821, the electronic device 20 may be worn on an outer portion 810 of a left wrist of the user. The control module 160 may be configured to activate the HRM sensor 171 and to collect a sensor signal in response to scheduled information or a user input. A sensor signal provided from the HRM sensor 171 may be represented as a graph 822. For example, the sensor signal collected by the HRM sensor 171 may be a wave signal within a specific range. If the HRM sensor 171 collects a sensor signal represented as the graph 822, the control module 160 may perform at least one of an operation of determining the corresponding sensor signal as a left wrist physiological signal relative to a format of a wave signal (e.g., a pattern of the wave signal) or an operation of determining a state where the electronic module 20 is worn on the outer portion 810 of the left wrist relative to a level of the corresponding sensor signal.

According to an embodiment, in state 823, the electronic module 20 is worn on an inner portion 820 of the left wrist of the user. A sensor signal provided from the HRM sensor 171 activated under control of the control module 160 may be represented as a graph 824. For example, the sensor signal collected by the HRM sensor 171 may be a wave signal, amplitude of which is greater than or equal to a specific range. If the HRM sensor 171 collects the sensor signal represented as the graph 824, the control module 160 may perform at least one of an operation of analyzing a characteristic of a wave signal and determining that the wave signal includes the left wrist physiological signal or an operation of determining a state where the electronic module 20 is worn on the inner portion 820 of the left wrist relative to a level of the wave signal.

According to an embodiment, in state 825, the electronic module 20 may be worn on the outer portion 810 of the left wrist of the user. Data in which a frequency of a sensor signal provided from the HRM sensor 171 activated under control of the control module 160 is analyzed may be represented as a graph 826. For example, the sensor signal collected by the HRM sensor 171 may be a signal in which a level value of a specific frequency is a first level value. If the HRM sensor 171 collects a sensor signal analyzed like the graph 826, the control module 160 may determine that the electronic module 20 is worn on the outer portion 810 of the left wrist of the user in an upper direction, relative to the specific frequency of the first level.

According to an embodiment, in state 827, the electronic device 20 may be worn on the outer portion 810 of the left wrist of the user. Data in which a frequency of a sensor signal provided from the HRM sensor 171 activated under control of the control module 160 is analyzed may be represented as a graph 828. For example, the sensor signal collected by the HRM sensor 171 may be a signal in which a level value of a specific frequency is a second level value. If the HRM sensor 171 collects a sensor signal analyzed like the graph 828, the control module 160 may determine that the electronic module 20 is worn on the outer portion 810 of the left wrist of the user in a lower direction, relative to the specific frequency of the second level. The control module 160 may employ a function execution mode in a different way or may employ a UI mode in a different way, based on a form where the electronic module 20 is worn.

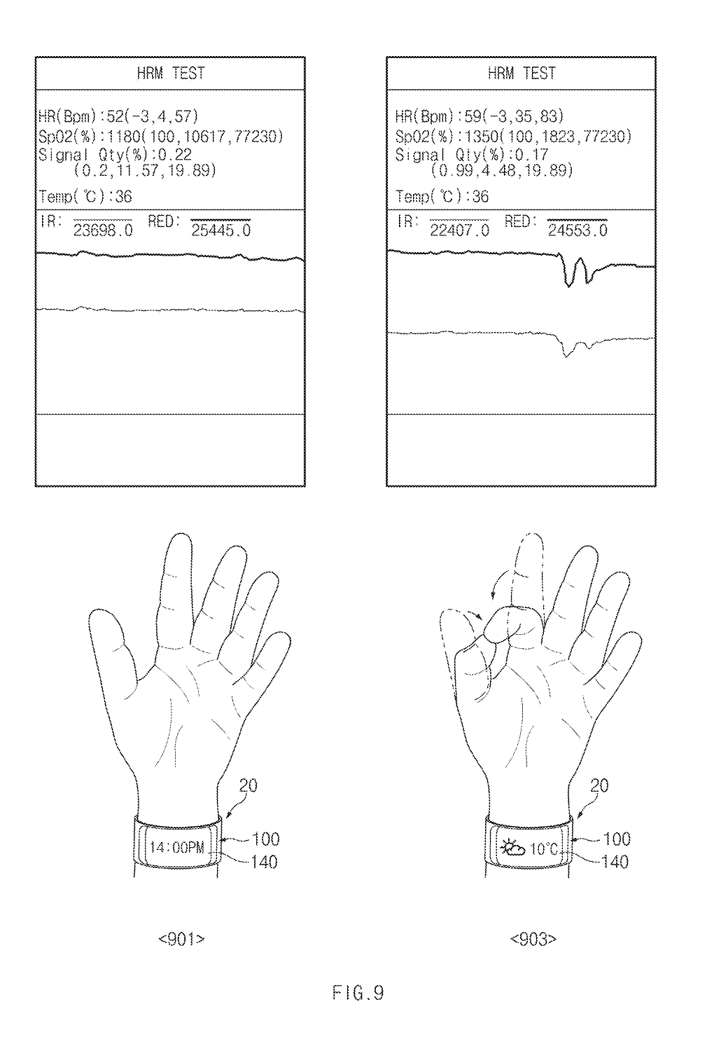

FIG. 9 is a drawing illustrating a graph associated with controlling function execution of an electronic device according to an embodiment of the present disclosure.

Referring to FIG. 9, if a specific portion (e.g., a finger and the like of a user of an electronic device 100) of the user moves in a state where the electronic device 100 is worn on a specific portion (e.g., a wrist and the like of the user), a physiological signal may be changed. For example, if the electronic device 100 is in the state where it is worn the wrist and the like, in state 901, a sensor signal of an HRM sensor 171 of FIG. 2 may be detected. According to an embodiment, if a physical change is in a specific operation state (e.g., a state where there is no physical change or a state where fingers are spread out, and the like) in the state, such as state 901, where the electronic device 100 is worn on the wrist, the HRM sensor 171 may detect a sensor signal of a form shown in FIG. 9. For example, the HRM sensor 171 may detect a sensor signal for a state where there is no physical change.

Herein, if a finger and the like moves while the HRM sensor 171 performs monitoring, in state 903, a control module 160 of FIG. 2 may detect a sensor signal. For example, if a physical change occurs in response to an operation of performing tapping using a thumb and a forefinger of the user in a state where fingers are spread out, the control module 160 may receive a sensor signal change based on the physical change from the HRM sensor 171. As shown in FIG. 9, the HRM sensor 171 may detect a sensor signal which has a change at a time when a physical change (e.g., tapping using the thumb and the forefinger) occurs. According to various embodiments, the control module 160 may detect a specific sensor change value at a time when a finger or hand of the user moves. According to an embodiment, the control module 160 may control a specific function in response to motion of a finger of the user. According to an embodiment, if the electronic device 100 is in the state, such as state 901, where there is no physical change or in a state where there is a physical change of a specific range value or less, the control module 160 may be configured to perform a first function (e.g., a time display function). After a physical change occurs in state 903, if determining a current state as a specific operation state (e.g., tapping using the thumb and the forefinger), the control module 160 may be configured to perform a second function (e.g., a weather display function). Herein, the control module 160 may be configured to execute various functions (e.g., a function of entering a privacy mode, a function of entering a public mode, a function of entering a guest mode, and the like) for each operation state based on a physical change.

According to various embodiments, the control module 160 may classify a finger operation into finger operations of various forms. The control module 160 may map a specific function for each classified form based on motion of a hand of the user, a type of a finger of the user, and a motion form of a finger of the user. If a specific operation occurs, the control module 160 may be configured to execute a mapped specific function. The control module 160 may be configured to control a function of an electronic device 100 based on an operation of a portion where the electronic device 100 is worn, without direct control of the electronic device 100 (or a user input).

According to an embodiment, the control module 160 may control a sensor to sense and collect physiological information, such as an amount of blood flow, blood pressure, and blood oxygen saturation (SpO₂), changed by a physical change of a portion, such as finger motion, finger tapping, first clenching/opening, and wrist motion, adjacent to the electronic device 100. The control module 160 may be configured to extract secondary information (e.g., one tap information, two tap information, N tap information, long tap information, and the like) as well as primary information (e.g., heartbeat information) based on the collected sensor signal and may perform the above-mentioned specific operations based on the extracted information.

According to an embodiment, the control module 160 may classify an operation based on occurrence of a tapping operation of the forefinger and the number of times of the tapping operation. For example, the control module 160 may classify an operation of hitting fingers with each other or a tap operation of tapping a specific finger on a table once, a repeated tap operation of performing tapping a number of times at intervals of a certain time (e.g., 100 ms<event<200 ms), a long tap operation of maintaining a physiological change signal by a tap operation during a certain time (e.g., 1000 ms or more and the like), and the like.

The control module 160 may perform a variety of processing by using the classified operations to execute a specific application of the electronic device 100. According to an embodiment, when the repeated tap operation occurs in a state where an incoming call (e.g., a call message, an alarm message, a voice over internet protocol (VoIP) connection request) is received, the control module 160 may determine that an input event corresponding to an incoming call connection or confirmation (e.g., OK) is generated. If the long tap operation occurs in a state where an incoming call is received, the control module 160 may determine that an input event such as incoming call connection rejection or channel establishment cancellation is generated.

According to an embodiment, if the repeated tap operation occurs in a state where notification such as a message or e-mail is received, the control module 160 may be configured to process a function of verifying contents of the received message or e-mail. For example, the control module 160 may output a screen, including contents of the received message or e-mail, on a display module 140.

According to an embodiment, if the repeated tap operation occurs in a state where a media control function is performed, the control module 160 may be configured to move to content sorted in an order subsequent to currently reproducing content in a content list. Also, if the long tap operation occurs in the state where the media control function is performed, the control module 160 may be configured to reproduce content sorted in a previous order in the content list.

According to an embodiment, if a sensor signal corresponding to a specific operation is detected in a state where a specific screen is output on the display module 140 or where a waiting screen, a menu screen, or a specific function execution screen is output on the display module 140, the control module 160 may change a screen. For example, while removing a current screen from the display module 140 when a tap operation occurs, the control module 160 may be configured to display another screen from a right side of an edge of the display module 140 to a left side thereof or from the left side of the edge of the display module 140 to the right side thereof. While removing a current screen from the display module 140 when a repeated tap operation occurs, the control module 160 may be configured to display another screen from the left side of the edge of the display module 140 to the right side thereof or from the right side of the edge of the display module 140 to the left side thereof. When a long tap operation occurs, the control module 160 may be configured to end a screen search function and to enter a screen indicated by the long tap operation (e.g., output the indicated screen as the full screen of the display module 140). In connection with preventing an input error operation of the electronic device 100, the control module 160 may process an input event for a specific operation (e.g., a tap operation and the like) which occurs within a certain time from a time when a previously defined specific event is generated.

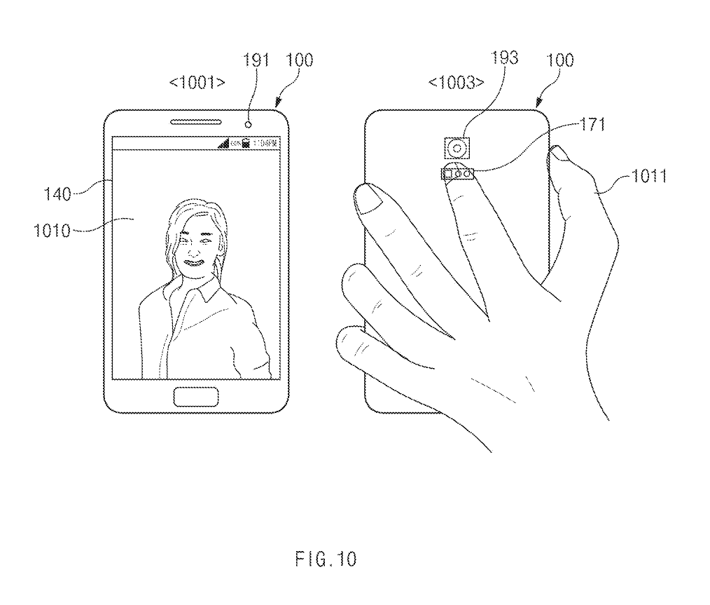

FIG. 10 is a drawing illustrating a camera control function of an electronic device according to various embodiments of the present disclosure.

Referring to FIG. 10, a control module 160 of FIG. 2 may activate a camera 191, included in an electronic device 100, based on a user input or scheduled information. For example, if an event associated with selecting a camera icon or a menu is generated, the control module 160 may activate the camera 191. In state 1001, a display module 140 may output a preview image, obtained based on the activation of the camera 191, on a screen 1010.

In state 1003, the electronic device 100 may include an HRM sensor 171 of FIG. 2, arranged in an opposite direction (or a rear direction) from a location where the display module 140 is disposed. According to various embodiments, the electronic device 100 may further include a camera 193 arranged in a region adjacent to a region where the HRM sensor 171 is disposed. According to an embodiment, if the camera 191 is activated or if an event associated with activating a camera function is generated, the control module 160 may activate the HRM sensor 171. The HRM sensor 171 may sense heartbeat of a user of the electronic device 100 in response to approach of the object 1011. The HRM sensor 171 may send the sensed information (e.g., physiological information) about the approached object 1011 to the control module 160.

The control module 160 may determine the approach of the object 1011 based on the sensed information. For example, the control module 160 may determine an approach of a user's finger of the electronic device 100 based on the sensed information provided from the HRM sensor 171. If heartbeat information is sensed based on the approach of the user's finger, the control module 160 may automatically perform a shutter function of the camera 191. Therefore, if the user approaches his or her finger to a specific location from the HRM sensor 171, the camera 91 may capture a preview image obtained at a corresponding time.

The control module 160 may be configured to perform notification that the object 1011 approaches to the HRM sensor 171, notification of an operation of sensing the object 1011, and notification of executing a shutter function based on sensed information. According to various embodiments, if a specific time elapses after the heartbeat of the user is sensed or if a heartbeat sensing time elapses by a specific time, the control module 160 may be configured to capture an image of the camera 191. The specific time may be adjusted by the user.

According to various embodiments, the control module 160 may convert sensed information (e.g., heartbeat information of the user) into audio data. The control module 160 may add the converted audio data to a captured image. According to various embodiments, the control module 160 may control image capturing based on specific heartbeat information of the user. For example, if sensed information obtained from the HRM sensor 171 is the same or similar to the specific heartbeat information or has the substantially same pattern as the specific heartbeat information, the control module 160 may control image capturing of the camera 191. If the obtained sensed information is different from the specific heartbeat information, the control module 160 may control the camera 191 not to perform image capturing of the camera 191.

According to various embodiments, the control module 160 may control operation of at least one of the camera 191 or the camera 193 based on operation of the HRM sensor 171. For example, the control module 160 may be configured to activate the camera 193 based on a setting or user control, to obtain a preview image, and to output the obtained preview image on the display module 140. In this operation, the control module 160 may activate the HRM sensor 171. If collecting the specific sensed information from the HRM sensor 171, the control module 160 may be configured to activate the camera 191. In this operation, the control module 160 may be configured to temporarily turn off the camera 193.

According to various embodiments, the control module 160 may be configured to simultaneously execute the camera 191 and the camera 193. If receiving sensed information from the HRM sensor 171, the control module 160 may control image capturing of the camera 191 or the camera 193. While the control module 160 performs the above-mentioned operations, the display module 140 may convert the obtained image. For example, while the display module 140 displays a preview image obtained by the camera 193, it may output a preview image, obtained by the camera 191, on the full screen based on reception of sensed information of the HRM sensor 171. According to various embodiments, the control module 160 may output a preview image obtained by the camera 193 on the full screen and may output a preview image obtained by the camera 191 on a picture in picture (PIP) screen. Alternatively, if obtaining the specific sensed information from the HRM sensor 171, the control module 160 may output a preview image obtained by the camera 191 on the full screen and may output a preview image obtained by the camera 193 on a PIP screen. As described above, the control module 160 may be configured to convert images collected by at least one camera in response to sensed information collected by the HRM sensor 171.

If sensed information is not received from the HRM sensor 171, the control module 160 may output a preview image obtained by the camera 193. The user may check a preview image obtained by the camera 193 and a preview image obtained by the camera 191 through the full screen of the display module 140 and may simultaneously capture the preview images, based on the above-mentioned operation. The simultaneously captured images may be synthesized or may be grouped and stored into a simultaneously captured image, based on a setting or user control. As described above, the user may use the HRM sensor 171 as a shutter function, a camera conversion function, or a screen change function, using his or her finger.

According to various embodiments, the electronic device 100 may adjust a sensed information operation in an operation of using the HRM sensor 171 as a shutter function of a camera. If an accurate heartbeat sensing result is drawn by sensed information obtained by the HRM sensor 171, the electronic device 100 may be configured to normally operate a shutter function. Alternatively, although a heartbeat sensing result is drawn as an error, the electronic device 100 may be configured to normally operate the shutter function.

According to various embodiments, the electronic device 100 may be configured to obtain a moving image, while the HRM sensor 171 senses information. For example, if the HRM sensor 171 obtains the specific sensed information, the control module 160 may be configured to start to capture a moving image using at least one of the camera 191 or the camera 193. If sensed information is not obtained from the HRM sensor 171 or if sensed information in which there is no approach of the object 1011 is obtained, the control module 160 may stop capturing a moving image. Therefore, the user may arrange his or her finger on the HRM sensor 171 at a time when he or she wants to capture a moving image and may separate his or her finger from the HRM sensor 171 if he or she wants to stop capturing the moving image. If an event associated with ending capture of a moving image is generated (e.g., if a virtual key button displayed on the display module 140 is selected or if a specific physical key button is selected), the control module 160 may end capture of the moving image. Before ending capture of the moving image, the control module 160 may automatically integrate intermittently obtained moving images to provide one video file.

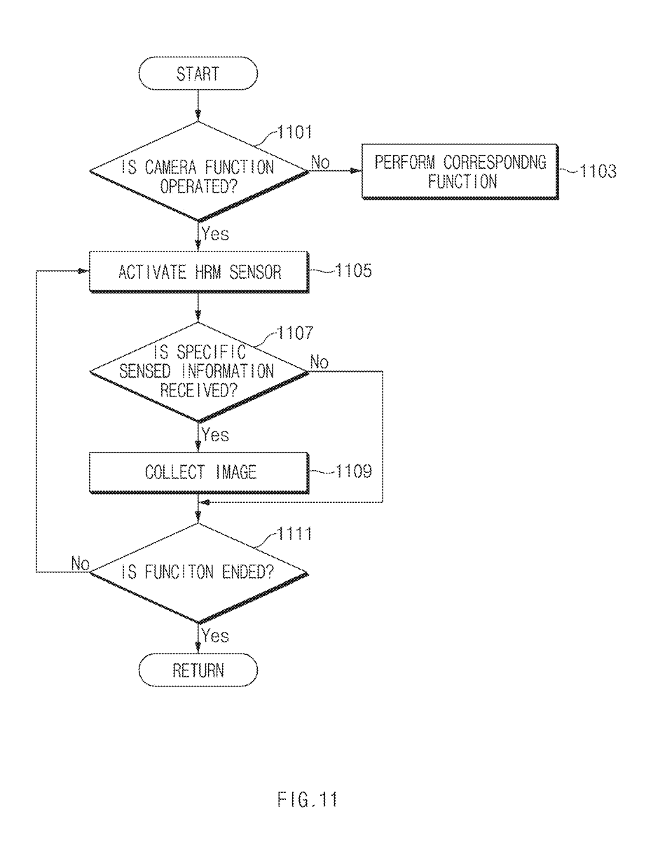

FIG. 11 is a flowchart illustrating a camera control method of an electronic device according to various embodiments of the present disclosure.

Referring to FIG. 11, in operation 1101 of the camera control method of the electronic device, if an event is generated, a control module 160 of FIG. 2 may determine whether the generated event is an event associated with operating a camera function. If the generated event is not the event associated with operating the camera function, in operation 1103, the control module 160 may be configured to execute a function corresponding to a type of the generated event. For example, the control module 160 may perform a content play function, a gallery function, a chat function, a game function, and the like based on the type of the generated event.

If the generated event is the event associated with operating the camera function, in operation 1105, the control module 160 may be configured to activate an HRM sensor 171 of FIG. 2. In this operation, the control module 160 may activate the HRM sensor 171 at a time when the camera function is activated and when a preview image is output on a display module 140 of FIG. 2. The HRM sensor 171 may determine an approach of an object in real time or at a certain period based on its activation. For example, the HRM sensor 171 may perform a sensing operation based on the approach of the object at a certain time or in real time.

In operation 1107, the control module 160 may determine whether specific sensed information (e.g., physiological information) is received. If the specific sensed information is received, in operation 1109, the control module 160 may be configured to collect an image through image capturing. After collecting the image, the control module 160 may be configured to automatically store the collected image or to output a pop-up window for inquiring about whether to store the collected image. In operation 1111, the control module 160 may determine whether a function ending event is generated. When the function ending event is generated, the control module 160 may end the function of the HRM sensor 171 or the camera function. In connection with ending the function of the HRM sensor 171, the control module 160 may provide a setting item, such as an icon or menu, associated with ending a shutter function of the HRM sensor 171. If the function ending event is not generated, the control module 160 may be configured to branch to operation 1105 and to maintain the state where the HRM sensor 171 is activated.

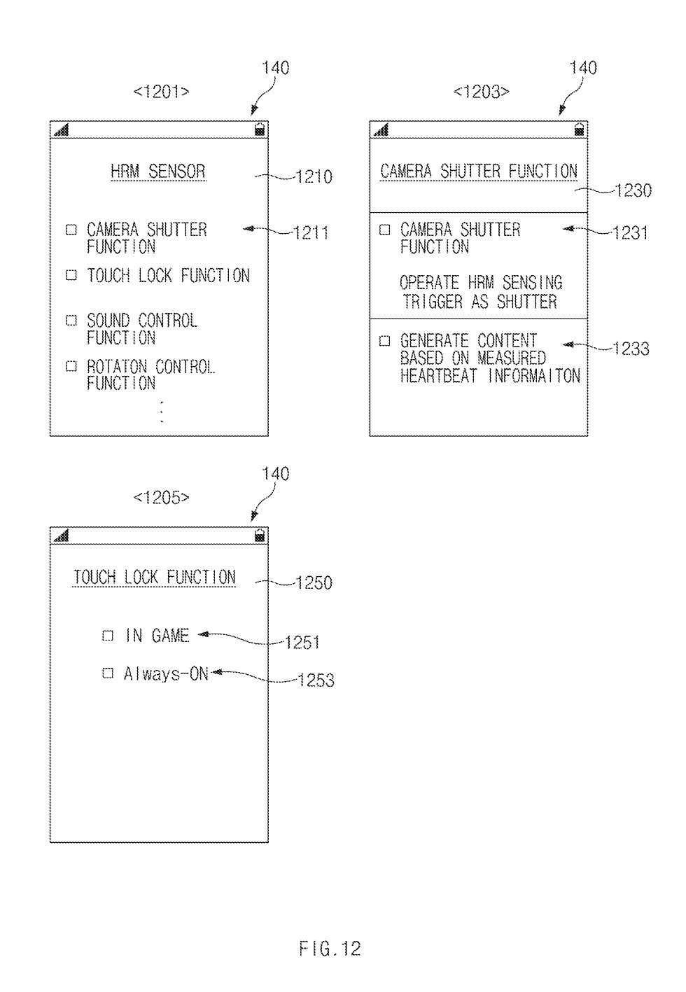

FIG. 12 is a drawing illustrating a sensor setting screen according to various embodiments of the present disclosure.

Referring to FIG. 12, in state 1210, a display module 140 may output a setting screen 1210 associated with setting an HRM sensor 171 of FIG. 2. In this regard, an electronic device 100 of FIG. 2 may provide a setting menu or a setting icon and the like associated with calling the setting screen 1210. The setting screen 1210 may include, for example, items associated with a camera shutter function, a touch lock function, a sound control function, a rotation control function, and the like. According to an embodiment, the camera shutter function may be a setting of operating the HRM sensor 171 as a shutter function of a camera 191 or 193 of FIG. 10. If the camera shutter function is set and if a camera function is operated as described with reference to FIG. 10, the electronic device 100 may control image capturing based on sensed information collected by the HRM sensor 171.

According to various embodiments, if the touch lock function is set, the electronic device 100 may support a function of setting or releasing touch lock in response to whether sensed information is obtained from the HRM sensor 171. For example, the electronic device 100 may activate the HRM sensor 171 in a state where a touch panel is activated (or a state where the touch panel is inactivated) or a state where an electronic pen function is activated (or a state where the electronic pen is inactivated) and may determine whether sensed information is obtained. If the HRM sensor 171 obtains specific sensed information, the electronic device 100 may turn off the activated touch panel or may turn on the inactivated touch panel.

According to various embodiments, in a state where the sound control function is set, if an audio data output function is activated, the electronic device 100 may activate the HRM sensor 171. If obtaining the specific sensed information from the HRM sensor 171, the electronic device 100 may control a sound. For example, the electronic device 100 may mute the sound. Alternatively, the electronic device 100 may convert a level of the sound into a maximum (or minimum) volume level.

According to various embodiments, in a state where the rotation control function is set, if a rotatable screen is output on the display module 140, the electronic device 100 may activate the HRM sensor 171. If obtaining the specific sensed information from the HRM sensor 171, the electronic device 100 may activate or inactivate a rotation function. If the rotatable screen is output, the electronic device 100 may guide that a screen may rotate based on the HRM sensor 171 (e.g., output specific information as a video or audio).

According to various embodiments, if an item 1211 associated with the camera shutter function is selected in state 1201, in state 1213, the control module 160 may output a detailed function setting screen 1230 on the display module 140. For example, the detailed function setting screen 1230 may include an item 1231 associated with describing the camera shutter function and an item 1233 associated with generating content about operation of content of obtained heartbeat information. If the content generation item 1233 is selected, the control module 160 may convert heartbeat information, obtained based on finger contact, into audio data in a process of capturing an image using a camera. The control module 160 may include the converted audio data in the captured image (e.g., a still image or a moving image).

According to various embodiments, if the item associated with the touch lock function is selected in state 1201, in state 1205, the control module 160 may output a state setting screen, for performing the touch lock function, on the display module 140. The state setting screen 1250 may display, for example, information for determining when to activate the HRM sensor 171, in connection with the touch lock function. For example, if an item 1251 associated with a game function is selected, the control module 160 may activate the HRM sensor 171 when the game function is executed and may control the touch lock function. If an always-on item 1253 is selected, the control module 160 may activate the HRM sensor 171 when the electronic device 100 is turned on and may control the touch lock function irrespective of a type of an application. According to various embodiments, the control module 160 may have a state where the HRM sensor 171 is activated in a state where the display module 140 is turned off. If obtaining the specific sensed information from the HRM sensor 171, the control module 160 may activate a touch panel. In this operation, a display panel which displays information may have a turned-off state. If a specific gesture event is generated on the touch panel, the control module 160 may activate the display module 140 or may execute or control a specific application function.

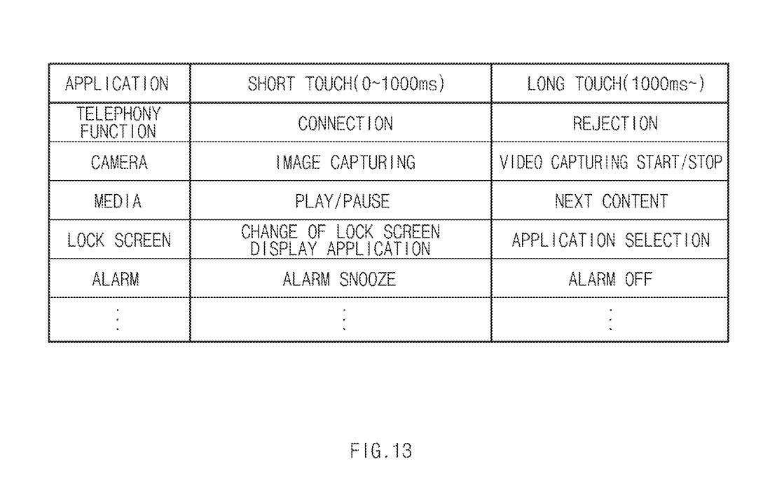

FIG. 13 is a drawing illustrating operation of an HRM sensor according to various embodiments of the present disclosure.

Referring to FIG. 13, an electronic device 100 of FIG. 2 may control various application functions in connection with operating an HRM sensor 171 of FIG. 2. In this regard, the HRM sensor 171 may have an always-on state or a turned-on state at a time where a corresponding function is executed. According to various embodiments, the HRM sensor 171 may support to convert settings associated with a call function, a camera function, a media function, a local screen function, an alarm function, and the like.

For example, if obtaining sensed information corresponding to a short touch (e.g., 0 to 1000 ms) from the HRM sensor 171, the control module 160 may execute a call connection function, an image capturing function, a play/pause function, a function of changing an application displayed on a lock screen, an alarm snooze function, and the like in response to a type of a currently executed application.

Also, if obtaining sensed information corresponding to a long touch (e.g., 1000 ms or more) from the HRM sensor 171, the control module 160 may execute a call rejection function, a video capturing start/end function, a next content convention function, an application selection function, an alarm off function, and the like in response to a type of a currently executed application.

According to various embodiments, if a telephony function is executed (e.g., if an incoming call is received, if a phonebook function is executed, or if a dial application is executed), the control module 160 may activate the HRM sensor 171. Alternatively, the HRM sensor 171 may have an always-on state. If obtaining specific sensed information from the HRM sensor 171 while the telephony function is executed, the control module 160 may perform a call connection or call rejection based on a type of the specific sensed information. According to various embodiments, the control module 160 may send a specific message as a response message to another electronic device together with performing call rejection, based on the type of the sensed information.

According to various embodiments, if an alarm function setting time arrives, the control module 160 may activate the HRM sensor 171. If obtaining the specific sensed information from the HRM sensor 171, the control module 160 may adjust a length of time, when a user of the electronic device 100 snoozes, based on a type of the sensed information (e.g., a contact time of an object), in a different way. For example, when a time when the object is in contact with the electronic device 100 is longer, the control module 160 may extend a time when the user snoozes (e.g., an interval of a time when an alarm is executed again). If a time when the object is in contact with the electronic device 100 is over a specific time, the control module 160 may turn off an alarm function. According to various embodiments, although the time when the object is in contact with the electronic device 100 is over the specific time, if determining that the user is in a sleeping state based on analysis of sensed information, the control module 160 may be configured to execute the alarm function again. In this regard, the control module 160 may store heartbeat information based on a sleeping pattern and may refer to the stored heartbeat information when executing the alarm function.

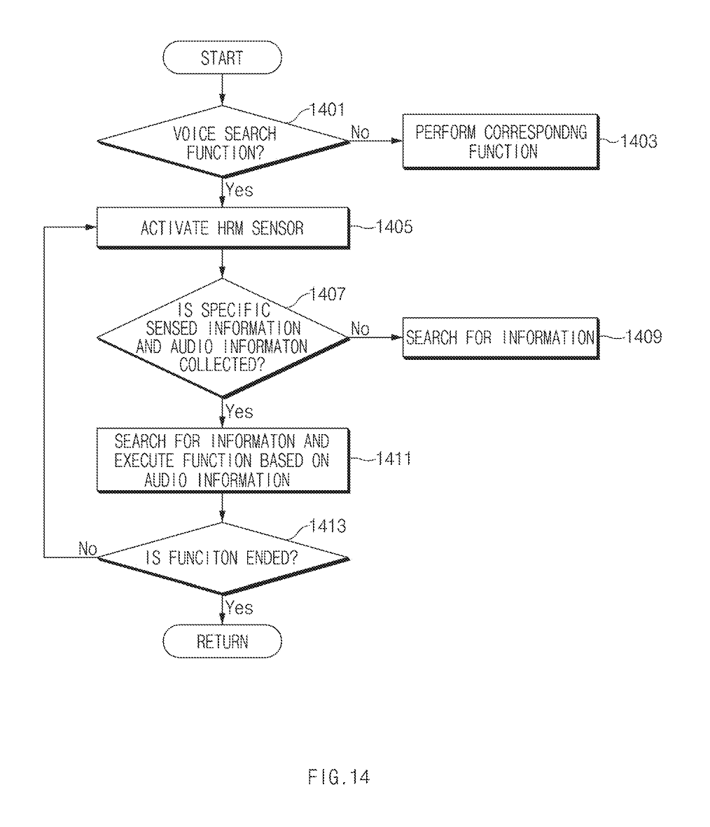

FIG. 14 is a flowchart illustrating a method for controlling a voice search function according to various embodiments of the present disclosure.

Referring to FIG. 14, in operation 1401 of the method for controlling the voice search function, if an event is generated, a control module 160 of FIG. 2 may determine whether the generated event is an event associated with the voice search function. For example, the control module 160 may determine whether an event for selecting an icon or menu associated with the voice search function is generated. According to various embodiments, an electronic device 100 of FIG. 2 may provide a microphone with an always-on state. Therefore, if audio information obtained through the microphone is specific audio information, the control module 160 may activate the voice search function.

If the generated event is not the event associated with the voice search function, in operation 1403, the control module 160 may perform a function corresponding to a type of the generated event. For example, the control module 160 may support a file replay function, a broadcasting receiving function, a webpage search function, and the like in response to the type of the generated event. Alternatively, the control module 160 may activate a camera function based on the type of the generated event.

If the generated event is the event associated with the voice search function, in operation 1405, the control module 160 may activate an HRM sensor 171 of FIG. 2. Also, the control module 160 may activate the voice search function. The control module 160 may activate the microphone and may collect audio information based on the activation of the voice search function.

After the HRM sensor 171 is activated, in operation 1407, the control module 160 may determine whether specific sensed information and audio information are collected. If the audio information is collected without the specific sensed information, in operation 1409, the control module 160 may search for information about the collected audio information. In this operation, if the audio information is not collected, the control module 160 may output the specific sensed information and guide information for requesting to input the audio information. If the specific sensed information is received without the audio information, the control module 160 may output guide information for requesting to input the audio information.

If the specific sensed information and the audio information are collected, in operation 1411, the control module 160 may search for information based on the audio information and may execute a function based on the found information. For example, if an audio associated with a map search is received as the audio information, the control module 160 may automatically execute a navigation function. Alternatively, if a music related audio is received as the audio information, the control module 160 may be configured to reproduce music corresponding to the corresponding audio or to reproduce a sound source registered in a specific music play list.

In operation 1413, the control module 160 may determine whether an end event associated with ending the voice search function is generated. If the end event is not generated, the control module 160 may branch to operation 1405 and may perform the operation again from operation 1405. When the end event is generated, the control module 160 may be configured to end the voice search function and to return to a specific function. In this operation, the control module 160 may be configured to inactivate the HRM sensor 171.

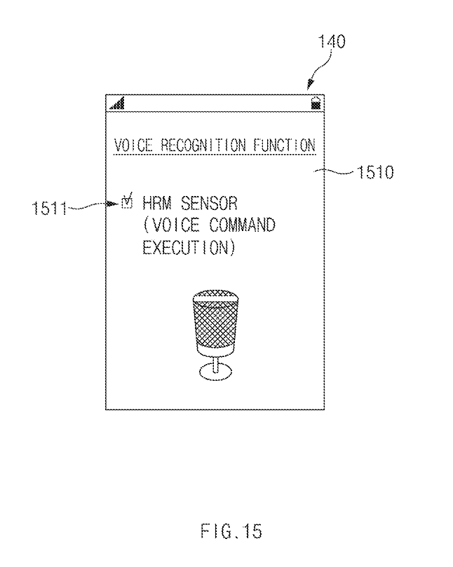

FIG. 15 is a drawing illustrating a screen interface associated with a voice recognition function according to various embodiments of the present disclosure.

Referring to FIG. 15, a display module 140 may output a function screen 1510 in connection with executing the voice recognition function. In this regard, an electronic device 100 of FIG. 2 may provide an icon or menu associated with executing the voice recognition function. Alternatively, the electronic device 100 may activate at least one microphone. If collecting specific voice information from the at least one microphone, the electronic device 100 may automatically execute the voice recognition function.

The function screen 1510 may include description information 1511 about an operation state of an HRM sensor 171 of FIG. 2. The description information 1511 may include information about whether the HRM sensor 171 is applied and description of a function performed when the HRM sensor 171 is applied. According to an embodiment, the description information 1511 may include a function execution list of audio information collected based on the HRM sensor 171. The description information 1511 may include, for example, a recent function execution list. A control module 160 of FIG. 2 may operate or inactivate the HRM sensor 171 in response to selection of the description information 1511.

According to various embodiments, the control module 160 may provide the HRM sensor 171 with an always-on state. If obtaining specific sensed information from the HRM sensor 171, the control module 160 may activate a microphone. The control module 160 may use audio information, collected through the microphone, as a keyword of a voice search function. The control module 160 may output the found result obtained based on the use of the keyword or may execute a function based on the found result.

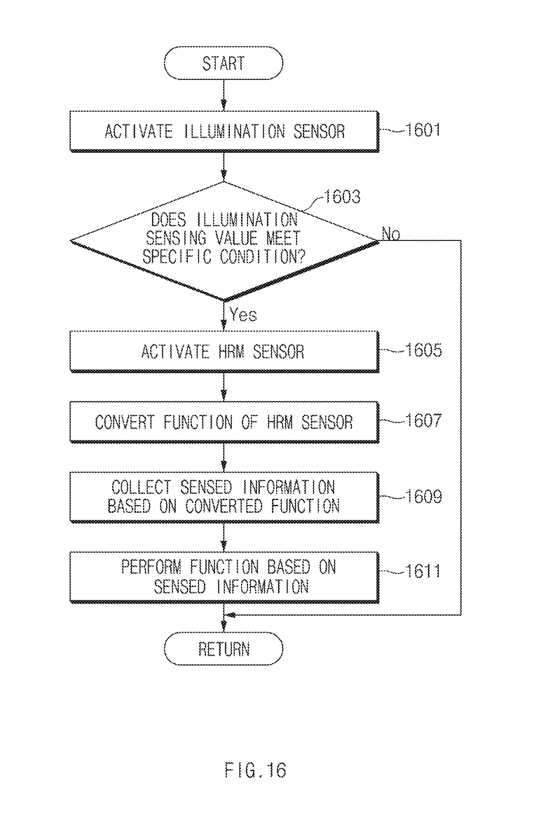

FIG. 16 is a flowchart illustrating a function conversion method of an HRM sensor according to various embodiments of the present disclosure.

Referring to FIG. 16, in operation 1601 of the function conversion method, a control module 160 of FIG. 2 may activate an illumination sensor. The illumination sensor may always have, for example, a turned-on state in a state where an electronic device 100 of FIG. 2 is turned on. Alternatively, the illumination sensor may be activated if a specific application of the electronic device 100 is executed.

In operation 1603, the control module 160 may determine whether an illumination sensing value meets a specific condition. If the illumination sensing value does not meet the specific condition, the control module 160 may skip subsequent operations. For example, the control module 160 may determine whether the illumination sensing value is less than a certain illumination value or is greater than or equal to the certain illumination value. Alternatively, the control module 160 may determine whether the illumination sensing value is a specific value in a state where a front surface of the electronic device 100 (e.g., the direction of a display module 140 of the FIG. 2 in which the illumination sensor is disposed) is faced with a desk.

If the illumination sensing value meets the specific condition, in operation 1605, the control module 160 may activate an HRM sensor 171 of FIG. 2. Alternatively, if a time when a change of the illumination sensing value meets a specific condition is maintained during a specific time, the control module 160 may activate the HRM sensor 171. Therefore, the control module 160 may prevent the HRM sensor 171 from frequently converting activation or inactivation based on a frequent change of the illumination sensing value.

In operation 1607, the control module 160 may convert a function of the HRM sensor 171. For example, the control module 160 may convert the function of the HRM sensor 171 into a proximity sensor function. Alternatively, the control module 160 may convert the function of the HRM sensor 171 into a sub-illumination sensor function.

In operation 1609, the control module 160 may collect sensed information based on the converted function. For example, the control module 160 may determine proximity of an object based on sensed information obtained based on performance of the proximity sensor function. Alternatively, the control module 160 may determine a change of an ambient illumination value based on sensed information obtained based on performance of the sub-illumination sensor function.

In operation 1611, the control module 160 may perform a function based on the sensed information. For example, if the illumination sensing value of the illumination sensor meets the specific condition and if sensed information based on the conversion function of the HRM sensor 171 is provided as a specific value, the control module 160 may activate at least one of specific applications of the electronic device 100. According to an embodiment, the control module 160 may automatically adjust brightness of a display module 140 of the electronic device 100 in response to the sensed information. Alternatively, the control module 160 may adjust an audio volume level as a specific value in response to the sensed information.

The control module 160 may perform a function return based on occurrence of an input event or scheduled information. For example, the control module 160 may constantly collect sensed information based on the function converted in operation 1609. Alternatively, the control module 160 may branch to operation 1607 and may convert a function of the HRM sensor 171 to perform a specific function based on a setting or an input event.

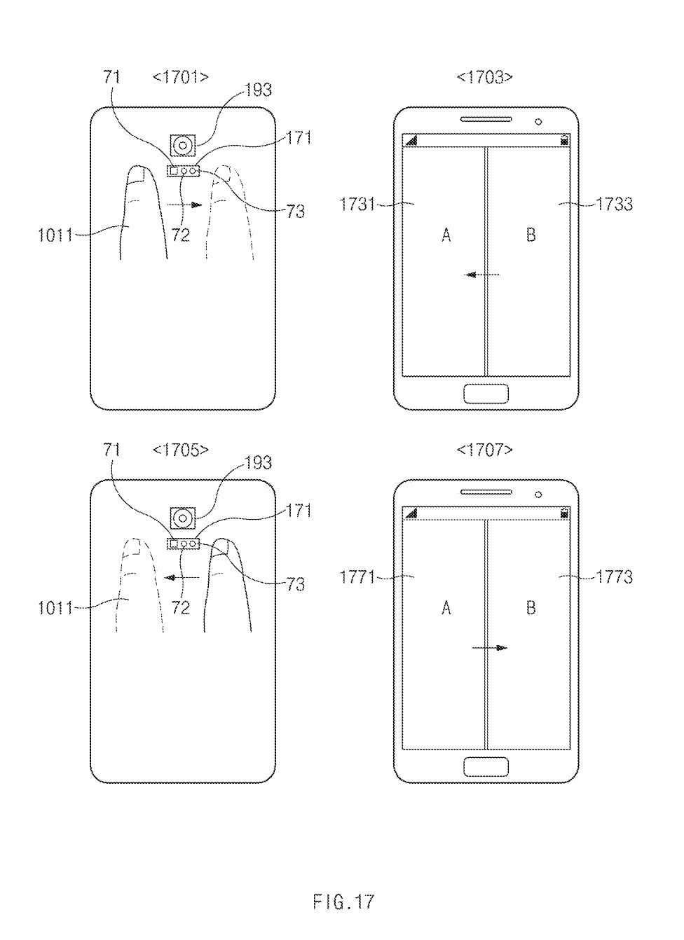

FIG. 17 is a drawing illustrating operation of a scroll function according to various embodiments of the present disclosure;

Referring to FIG. 17, in connection with the operation of the scroll function, in state 1701, an electronic device 100 of FIG. 2 may include, for example, an HRM sensor 171 including an infrared ray (IR) emitting unit 73, an IR receiving unit 72, a LED 71. According to various embodiments, the HRM sensor 171 may send light through the IR emitting unit 73. If sensing an approach of an object, the HRM sensor 171 may emit light through the LED 71 and may collect a change of sensed information based on movement of an object 1011 based on information collected through the IR receiving unit 72. According to various embodiments, the electronic device 100 may further include a camera 193. The camera 193 may be omitted based on a type of the electronic device 100.

In state 1701, if the object 1011 moves in a right direction from a left side, a control module 160 of FIG. 2 may recognize the movement of the object 1011. In this regard, the control module 160 may collect a change of sensed information based on the movement of the object 1011 from the HRM sensor 171. If the collected changed of the sensed information is a specific pattern change, the control module 160 may determine that the object 1011 moves (e.g., that the object 1011 moves in the right direction from the left side).

If the object 1011 moves in the right direction from the left side, in state 1703, the control module 160 may change a screen. For example, the control module 160 may remove a screen 1731, displayed as the full screen of a display module 140 of FIG. 2, from the display module 140 while moving the screen 1731 in a left direction and may display a screen 1733 on the display module 140 while moving the screen 1733 in a left direction from a right side. The control module 160 may move the screen 1733 to display the screen 1733 as the full screen of the display module 140.

In state 1705, if the object 1011 moves in the left direction from the right side of the HRM sensor 171, the HRM sensor 171 may send sensed information corresponding to the movement of the object 1011 to the control module 160. If a change of sensed information based on the movement of the object 1011, obtained from the HRM sensor 171, is a specific pattern change, the control module 160 may determine that the object 1011 moves (e.g., that the object 1011 moves in the left direction from the right side).

If the object 1011 moves in the left direction from the right side, in state 1707, the control module 160 may change a screen. For example, the control module 160 may remove a screen 1773, displayed as the full screen of the display module 140, from the display module 140 while moving the screen 1731 in a right direction and may display a screen 1771 on the display module 140 while moving the screen 1771 in the right direction from the left side. The control module 160 may move the screen 1771 to display the screen 1771 as the full screen of the display module 140.

According to various embodiments, if collecting sensed information based on a scroll operation from the left side to the right side or a scroll operation from the right side to the left side, the control module 160 may provide a book turning function, a photo search function of a gallery, a webpage turning function, a function of searching for a plurality of background execution pages, and the like.

According to various embodiments, an electronic device may include an HRM sensor configured to always maintain an activation state in a state where the electronic device is turned on and to be activated when a specific application is executed and a control module configured to execute a specific function of a currently executing application.

According to various embodiments, the electronic device may further include a camera.

According to various embodiments, the control module may be configured to automatically execute a shutter function of the camera if specific sensed information is obtained.

According to various embodiments, the control module may be configured to automatically execute a video capturing start function or a video capturing stop function of the camera if specific sensed information is obtained.

According to various embodiments, the control module may be configured to inactivate an activated camera or to activate an inactivated camera among a plurality of cameras if specific sensed information is obtained.

According to various embodiments, the control module may be configured to convert displaying of a preview image obtained by a specific camera into displaying of a preview image obtained by another camera if specific sensed information is obtained.

According to various embodiments, the control module may be configured to capture a moving image while obtaining of specific sensed information from the HRM sensor is maintained and to stop capturing the moving image if the specific sensed information is not obtained.

According to various embodiments, the control module may be configured to integrate intermittently obtained moving images into one file when a video capturing end event is generated.

According to various embodiments, the control module may be configured to generate audio data corresponding to heartbeat information and to include the generated audio data in the captured image.

According to various embodiments, the control module may be configured to capture a camera image if a specific time elapses after heartbeat of a user of the electronic device is sensed.

According to various embodiments, the control module may be configured to control image capturing of the camera when sensed information corresponding to specific heartbeat information of a user is obtained.

According to various embodiments, the control module may be configured to adjust a size of a preview image collected by a first camera and a size of a preview image collected by a second camera in response to sensed information collected by the HRM sensor.

According to various embodiments, the control module may be configured to output a preview image collected by a first camera on the full screen, to output a preview image collected by a second camera on a PIP screen, and to change a location of the full screen and the PIP screen in response to sensed information collected by the HRM sensor.

According to various embodiments, the electronic device may further include a microphone. The control module may be configured to activate the HRM sensor based on occurrence of an input event or collection of a specific audio signal. The control module may be configured to recognize collected audio information as a voice and to execute a function based on the voice recognition result if the audio information is collected in a state where specific sensed information is collected from the HRM sensor.

According to various embodiments, the control module may be configured to adjust at least one of a snooze time or an alarm off function of a specific alarm function.

According to various embodiments, the control module may be configured to adjust a snooze time of an alarm function (e.g., adjust the snooze time of the alarm function to be shorter) if determining that sensed information has a sleeping pattern by analyzing the sensed information.

According to various embodiments, a method for operating an electronic device may include always activating an HRM sensor or activating the HRM sensor when a specific application is executed and executing a specific function of a currently executing application based on sensed information collected by the HRM sensor.

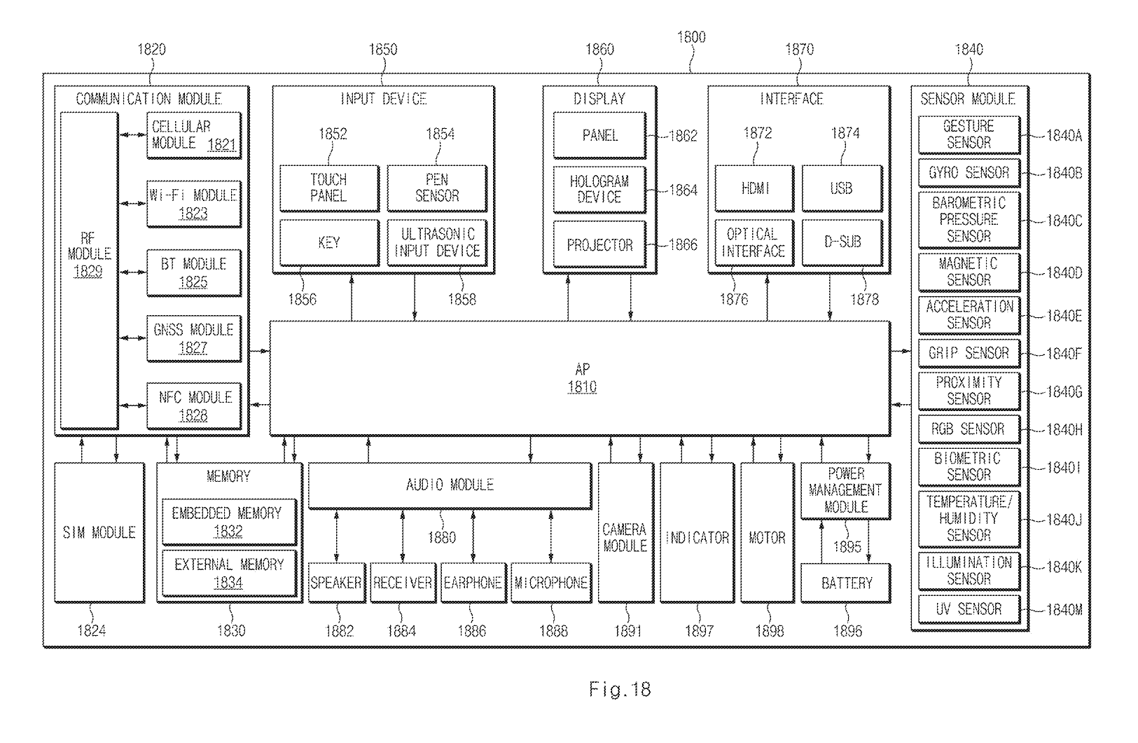

FIG. 18 is a block diagram illustrating a configuration of an electronic device according to various embodiments of the present disclosure.

Referring to FIG. 18, an electronic device 1801 may include, for example, all or part of an electronic device shown in FIG. 2. The electronic device 1801 may include one or more APs 1810 (e.g., a control module 160), a communication module 1820, a subscriber identification module (SIM) card 1824, a memory 1830, a sensor module 1840, an input device 1850, a display 1860, an interface 1870, an audio module 1880, a camera module 1891, a power management module 1895, a battery 1896, an indicator 1897, and a motor 1898.

The AP 1810 may drive, for example, an operating system (OS) or an application program to control a plurality of hardware or software components connected thereto and may process and compute a variety of data. The AP 1810 may be implemented with, for example, a system on chip (SoC). According to an embodiment, the AP 1810 may include a graphics processing unit (GPU) (not shown) and/or an image signal processor (not shown). The AP 1810 may include at least some (e.g., a cellular module 1821) of the components shown in FIG. 18. The AP 1810 may load instructions or data received from at least one of other components (e.g., a non-volatile memory) into a volatile memory to process the data and may store various data in a non-volatile memory.

The communication module 1820 may have the same or similar configuration to a communication interface 130 of FIG. 2. The communication module 1820 may include, for example, the cellular module 1821, a Wi-Fi module 1823, a BT module 1825, a global positioning system (GPS) module 1827, a near field communication (NFC) module 1828, and a radio frequency (RF) module 1829.

The cellular module 1821 may provide, for example, a voice call service, a video call service, a text message service, or an internet service, and the like through a communication network. According to an embodiment, the cellular module 1821 may identify and authenticate the electronic device 1801 in a communication network using a SIM (e.g., the SIM card 1824). According to an embodiment, the cellular module 1821 may perform at least part of functions which may be provided by the AP 1810. According to an embodiment, the cellular module 1821 may include a communication processor (CP).

The Wi-Fi module 1823, the BT module 1825, the GPS module 1827, or the NFC module 1828 may include, for example, a processor for processing data transmitted and received through the corresponding module. According to various embodiments, at least some (e.g., two or more) of the cellular module 1821, the Wi-Fi module 1823, the BT module 1825, the GPS module 1827, or the NFC module 1828 may be included in one integrated chip (IC) or one IC package.

The RF module 1829 may transmit and receive, for example, a communication signal (e.g., an RF signal). Though not shown, the RF module 1829 may include, for example, a transceiver, a power amplifier module (PAM), a frequency filter, or a low noise amplifier (LNA), or an antenna, and the like. According to another embodiment, at least one of the cellular module 1821, the Wi-Fi module 1823, the BT module 1825, the GPS module 1827, or the NFC module 1828 may transmit and receive an RF signal through a separate RF module.

The SIM card 1824 may include, for example, a card which includes a SIM and/or an embedded SIM. The SIM card 1824 may include unique identification information (e.g., an integrated circuit card identifier (ICCID)) or subscriber information (e.g., an international mobile subscriber identity (IMSI)).

The memory 1830 (e.g., a storage module 150 of FIG. 2) may include, for example, an embedded memory 1832 or an external memory 1834. The embedded memory 1832 may include at least one of, for example, a volatile memory (e.g., a dynamic random access memory (DRAM), a static RAM (SRAM), a synchronous DRAM (SDRAM), and the like), or a non-volatile memory (e.g., a one-time programmable read only memory (OTPROM), a PROM, an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 1834 may include a flash drive, for example, a compact flash (CF), a secure digital (SD), a micro-SD, a mini-SD, an extreme digital (xD), a multimedia card (MMC), or a memory stick, and the like. The external memory 734 may operatively and/or physically connect with the electronic device 201 through various interfaces.

The sensor module 1840 may measure, for example, a physical quantity or may detect an operation state of the electronic device 1801, and may convert the measured or detected information to an electric signal. The sensor module 1840 may include at least one of, for example, a gesture sensor 1840A, a gyro sensor 1840B, a barometric pressure sensor 1840C, a magnetic sensor 1840D, an acceleration sensor 1840E, a grip sensor 1840F, a proximity sensor 1840G, a color sensor 1840H (e.g., red, green, blue (RGB) sensor), a biometric sensor 1840I, a temperature/humidity sensor 1840J, an illumination sensor 1840K, or an ultraviolet (UV) sensor 1840M. Additionally or alternatively, the sensor module 1840 may further include, for example, an e-nose sensor (not shown), an electromyography (EMG) sensor (not shown), an electroencephalogram (EEG) sensor (not shown), an electrocardiogram (ECG) sensor (not shown), an IR sensor (not shown), an iris sensor (not shown), and/or a fingerprint sensor (not shown), and the like. The sensor module 1840 may further include a control circuit for controlling at least one or more sensors included therein. According to various embodiments, the electronic device 1801 may further include a processor configured to control the sensor module 1840, as part of the AP 1810 or to be independent of the AP 1810. While the AP 1810 is in a sleep state, the electronic device 1801 may control the sensor module 1840.

The input device 1850 may include, for example, a touch panel 1852, a (digital) pen sensor 1854, a key 1856, or an ultrasonic input unit 1858. The touch panel 1852 may use at least one of, for example, a capacitive type, a resistive type, an infrared type, or an ultrasonic type. Also, the touch panel 1852 may further include a control circuit. The touch panel 1852 may further include a tactile layer and may provide a tactile reaction to a user.

The (digital) pen sensor 1854 may be, for example, part of the touch panel 1852 or may include a separate sheet for recognition. The key 1856 may include, for example, a physical button, an optical key, or a keypad. The ultrasonic input unit 1858 may allow the electronic device 1801 to detect a sound wave using a microphone (e.g., a microphone 1888) and to verify data through an input tool generating an ultrasonic signal.

The display 1860 (e.g., a display module 140 of FIG. 2) may include a panel 1862, a hologram device 1864, or a projector 1866. The panel 1862 may include the same or similar configuration to the display module 140. The panel 1862 may be implemented to be, for example, flexible, transparent, or wearable. The panel 1862 and the touch panel 1852 may be integrated into one module. The hologram device 1864 may show a stereoscopic image in a space using interference of light. The projector 1866 may project light onto a screen to display an image. The screen may be positioned, for example, inside or outside the electronic device 1801. According to an embodiment of the present disclosure, the display 1860 may further include a control circuit for controlling the panel 1862, the hologram device 1864, or the projector 1866.

The interface 1870 may include, for example, a high-definition multimedia interface (HDMI) 1872, a universal serial bus (USB) 1874, an optical interface 1876, or a D-subminiature 1878. The interface 1870 may be included in, for example, a communication interface 130 shown in FIG. 2. Additionally or alternatively, the interface 1870 may include, for example, a mobile high definition link (MHL) interface, an SD card/MMC interface, or an infrared data association (IrDA) standard interface.

The audio module 1880 may convert a sound and an electric signal in dual directions. At least part of components of the audio module 1880 may be included in, for example, an input and output module 120 shown in FIG. 2. The audio module 1880 may process sound information input or output through, for example, a speaker 1882, a receiver 1884, an earphone 1886, or the microphone 1888, and the like.

The camera module 1891 may be a device which captures a still image and a moving image. According to an embodiment, the camera module 1891 may include one or more image sensors (not shown) (e.g., a front sensor or a rear sensor), a lens (not shown), an image signal processor (ISP) (not shown), or a flash (not shown) (e.g., an LED or a xenon lamp).

The power management module 1895 may manage, for example, power of the electronic device 1801. According to an embodiment, though not shown, the power management module 1895 may include a power management IC (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 1896 and voltage, current, or temperature thereof while the battery 1896 is charged. The battery 1896 may include, for example, a rechargeable battery or a solar battery.

The indicator 1897 may display a specific state of the electronic device 1801 or part (e.g., the AP 1810) thereof, for example, a booting state, a message state, or a charging state, and the like. The motor 1898 may convert an electric signal into mechanical vibration and may generate vibration or a haptic effect, and the like. Though not shown, the electronic device 1801 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a mediaFlo™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

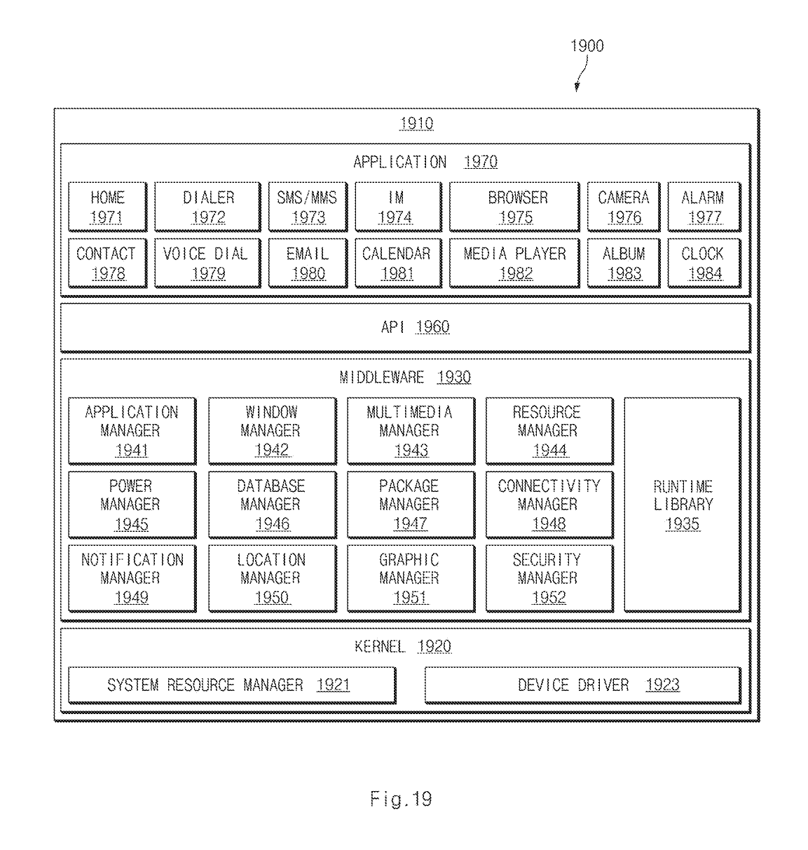

FIG. 19 is a block diagram illustrating a configuration of a program module according to various embodiments of the present disclosure.

Referring to FIG. 19, according to an embodiment, a program module 1910 may include an OS for controlling resources associated with an electronic device (e.g., an electronic device 100 of FIG. 2) and/or various applications which are executed on the OS. The OS may be, for example, Android, iOS, Windows, Symbian, Tizen, or Bada, and the like.

The program module 1910 may include an OS and at least one application 1970. The OS may include a kernel 1920, a middleware 1930, and an application programming interface (API) 1960. At least part of the program module 1910 may be preloaded on the electronic device, or may be downloaded from a server.

The kernel 1920 may include, for example, a system resource manager 1921 or a device driver 1923. The system resource manager 1921 may control, assign, or collect, and the like system resources. According to an embodiment, the system resource manager 1921 may include a process management unit, a memory management unit, or a file system management unit, and the like. The device driver 1923 may include, for example, a display driver, a camera driver, a BT driver, a shared memory driver, a USB driver, a keypad driver, a Wi-Fi driver, an audio driver, or an inter-process communication (IPC) driver.

The middleware 1930 may provide, for example, functions the application 1970 needs in common, and may provide various functions to the application 1970 through the API 1960 such that the application 1970 efficiently uses limited system resources in the electronic device. According to an embodiment, the middleware 1930 may include at least one of a runtime library 1935, an application manager 1941, a window manager 1942, a multimedia manager 1943, a resource manager 1944, a power manager 1945, a database manager 1946, a package manager 1947, a connectivity manager 1948, a notification manager 1949, a location manager 1950, a graphic manager 1951, and a security manager 1952.

The runtime library 1935 may include, for example, a library module used by a compiler to add a new function through a programming language while the application 1970 is executed. The runtime library 1935 may perform a function about input and output management, memory management, or an arithmetic function.

The application manager 1941 may manage, for example, a life cycle of at least one of the at least one application 1970. The window manager 1942 may manage graphical UI (GUI) resources used on a screen of the electronic device. The multimedia manager 1943 may ascertain a format necessary for reproducing various media files and may encode or decode a media file using a codec corresponding to the corresponding format. The resource manager 1944 may manage source codes of at least one of the at least one application 1970, and may manage resources of a memory or a storage space, and the like.

The power manager 1945 may act together with, for example, a basic input/output system (BIOS) and the like, may manage a battery or a power source, and may provide power information necessary for an operation of the electronic device. The database manager 1946 may generate, search, or change a database to be used in at least one of the at least one application 1970. The package manager 1947 may manage installation or update of an application distributed in the form of a package file.

The connectivity manager 1948 may manage, for example, wireless connection such as Wi-Fi connection or BT connection, and the like. The notification manager 1949 may display or notify events, such as an arrival message, an appointment, and proximity notification, by a method which is not disturbed to the user. The location manager 1950 may manage location information of the electronic device. The graphic manager 1951 may manage a graphic effect to be provided to the user or a UI related to the graphic effect. The security manager 1952 may provide all security functions necessary for system security or user authentication, and the like. According to an embodiment, when the electronic device (e.g., the electronic device 100) has a phone function, the middleware 1930 may further include a telephony manager (not shown) for managing a voice or video communication function of the electronic device. The middleware 1930 may further include a payment manager (not shown). The payment manager may relay information for payment from the application 1970 to the application 1970 or the kernel 1920. Also, the payment manager may send information, associated with payment, received from the external device in the electronic device or may send information stored in the electronic device to the external device.

The middleware 1930 may include a middleware module which configures combinations of various functions of the above-described components. The middleware 1930 may provide a module which specializes according to kinds of OSs to provide a differentiated function. Also, the middleware 1930 may dynamically delete some of old components or may add new components.

The API 1960 may be, for example, a set of API programming functions, and may be provided with different components according to OSs. For example, in case of Android or iOS, one API set may be provided according to platforms. In case of Tizen, two or more API sets may be provided according to platforms.

The application 1970 may include one or more of, for example, a home application 1971, a dialer application 1972, a short message service (SMS)/multimedia message service (MMS) application 1973, an instant message (IM) application 1974, a browser application 1975, a camera application 1976, an alarm application 1977, a contact application 1978, a voice dial application 1979, an e-mail application 1980, a calendar application 1981, a media player application 1982, an album application 1983, a clock application 1984, a health care application (e.g., an application for measuring quantity of exercise or blood sugar, and the like), or an environment information application (e.g., an application for providing atmospheric pressure information, humidity information, or temperature information, and the like), and the like.

According to an embodiment, the application 1970 may include an application (hereinafter, for better understanding and ease of description, referred to as “information exchange application”) for exchanging information between the electronic device (e.g., the electronic device 100) and an external electronic device (e.g., an electronic device 102 of FIG. 2). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the electronic device 102). Also, the notification relay application may receive, for example, notification information from the external electronic device, and may provide the received notification information to the user of the electronic device. The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the electronic device 102) which communicates with the electronic device, an application which operates in the external electronic device, or a service (e.g., a call service or a message service) provided from the external electronic device.

According to an embodiment, the application 1970 may include an application (e.g., the health card application of a mobile medical device) which is preset according to attributes of the external electronic device (e.g., the electronic device 102). According to an embodiment, the application 1970 may include an application received from the external electronic device (e.g., the electronic device 102). According to an embodiment, the application 1970 may include a preloaded application or a third party application which may be downloaded from a server. Names of the components of the program module 1910 according to various embodiments of the present disclosure may differ according to kinds of OSs.

According to various embodiments, at least part of the program module 1910 may be implemented with software, firmware, hardware, or at least two or more combinations thereof. At least part of the program module 1910 may be implemented (e.g., executed) by, for example, a processor (e.g., an AP 1810 of FIG. 18). At least part of the program module 1910 may include, for example, a module, a program, a routine, sets of instructions, or a process, and the like for performing one or more functions. Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific IC (ASIC) chip, field-programmable gate arrays (FPGAs), or a programmable-logic device, which is well known or will be developed in the future, for performing certain operations.

According to various embodiments, at least part of a device (e.g., modules or the functions) or a method (e.g., operations) may be implemented with, for example, instructions stored in computer-readable storage media in the form of a program module. When the instructions are executed by one or more processors (e.g., a control module 160 of FIG. 2), the one or more processors may perform functions corresponding to the instructions. The computer-readable storage media may be, for example, a storage module 150 of FIG. 2. At least part of the programming module may be implemented by, for example, the control module 160. At least part of the programming module may include, for example, a module, a program, a routine, sets of instructions, or a process, for performing one or more functions.

The computer-readable storage media may include magnetic media such as a hard disc, a floppy disk, and a magnetic tape; optical media such as a compact disc ROM (CD-ROM) and a DVD; magneto-optical media such as a floptical disk); a hardware device, such as a ROM, a RAM, and a flash memory, specially configured to store and perform program instructions (e.g., a program module). Also, the program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

Modules or program modules according to various embodiments of the present disclosure may include at least one or more of the above-mentioned components, some of the above-mentioned components may be omitted, or other additional components may be further included. Operations executed by modules, program modules, or other components may be executed by a successive method, a parallel method, a repeated method, or a heuristic method. Also, some operations may be executed in a different order or may be omitted, and other operations may be added.

According to various embodiments, a computer recording medium may include instructions which may be executed by at least one processor. The instructions may be set to always activate an HRM sensor or to activate the HRM sensor when a specific application is executed and to execute a specific function of a currently executing application based on sensed information collected by the HRM sensor.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. An electronic device comprising:
a sensor module configured to collect a signal; and
at least one of a module configured to generate physiological signal based on at least part of the collected signal, a module configured to generate proximity information based on at least part of the collected signal, or a module configured to generate illumination information based on at least part of the collected signal; and
a processor configured to determine a state where the electronic device is worn, based on at least one of the physiological signal, the proximity information, or the illumination information,
wherein the processor outputs information of the electronic device in a different form in response to the state where the electronic device is worn.

2. The electronic device of claim 1, wherein the processor is configured to detect changed physiological information of at least one of an amount of blood flow, blood pressure, blood oxygen saturation, or a heart rate, changed in response to a physical change of a portion where the electronic device is worn, determines the state where the electronic device is worn, based on the physiological information and the physical change, and execute an operation of the electronic device based on the state where the electronic device is worn.

3. The electronic device of claim 1, wherein the processor is configured to determine a portion where the electronic device is worn, based on at least one of a frequency domain characteristic or a time domain characteristic of the physiological information; or
wherein the processor is configured to determine whether the electronic device is worn, based on analysis of the proximity information and determine a portion where the electronic device is worn, based on the determination whether the electronic device is worn and physiological signal analysis information.

4. The electronic device of claim 1, further comprising:
a memory configured to store physiological information in a state where the electronic device is worn on a portion of a wearer as reference information corresponding to physiological information for each portion,
wherein the processor is configured to determine the state where the electronic device is worn and a portion where the electronic device is worn by comparing similarity between the reference information and collected information.

5. The electronic device of claim 1, wherein the processor is configured to output information to be displayed in at least one of a landscape arrangement horizontal writing mode, a landscape arrangement vertical writing mode, a portrait arrangement horizontal writing mode, a portrait arrangement vertical writing mode, an inverted mode, a mode of changing an output location of a soft button associated with executing a function in response to the state where the electronic device is worn, or a mode of changing an execution function type of a soft button output on a display module in response to the state where the electronic device is worn, in response to the state where the electronic device is worn.

6. The electronic device of claim 1, wherein the processor is configured to provide notification that an event of the electronic device is generated, in response to the state where the electronic device is worn or output at least part of information about contents of a generated event of the electronic device in response to the state where the electronic device is worn; or
wherein the processor is configured to verify authentication based on a state where the electronic device is not worn.

7. The electronic device of claim 1, wherein the processor is configured to determine the proximity information and output information about the state where the electronic device is worn or a state where the electronic device is not worn, through the electronic device or an external electronic device; or
wherein the processor is configured to automatically determine whether a user of the electronic device enters a sleeping state, based on the physiological information, acceleration information, and gyro information.

8. A method for operating an electronic device, the method comprising:
collecting a signal; and
determining a state where the electronic device is worn, based on at least one of physiological signal based on at least part of the collected signal, proximity information based on at least part of the collected signal, or illumination information based on at least part of the collected signal.

9. The method of claim 8, further comprising:
outputting information of the electronic device in a different form in response to the state where the electronic device is worn.

10. The method of claim 8, further comprising:
detecting changed physiological information of at least one of an amount of blood flow, blood pressure, blood oxygen saturation, or a heart rate, changed in response to a physical change of a portion where the electronic device is worn;
determining the state where the electronic device is worn, based on the physiological information and the physical change; and
performing an operation of the electronic device based on the state where the electronic device is worn.

11. The method of claim 8, further comprising:
determining a portion where the electronic device is worn, based on at least one of a frequency domain characteristic or a time domain characteristic of the physiological information; or
determining whether the electronic device is worn, based on analysis of the proximity information and determining a portion where the electronic device is worn, based on the determination whether the electronic device is worn and physiological signal analysis information.

12. The method of claim 8, further comprising:
determining the state where the electronic device is worn and a portion where the electronic device is worn by comparing similarity between reference information and collected information based on the stored reference information corresponding to physiological information in a state where the electronic device is worn on a portion of a wearer.

13. The method of claim 8, further comprising:
outputting information to be displayed in at least one of a landscape arrangement horizontal writing mode, a landscape arrangement vertical writing mode, a portrait arrangement horizontal writing mode, a portrait arrangement vertical writing mode, or an inverted mode, in response to the state where the electronic device is worn; and
outputting information to be displayed in at least one of a mode of changing an output location of a soft button associated with executing a function in response to the state where the electronic device is worn or a mode of changing an execution function type of a soft button output on a display module in response to the state where the electronic device is worn, in response to the state where the electronic device is worn.

14. The method of claim 8, further comprising:
one of providing notification that an event of the electronic device is generated, in response to the state where the electronic device is worn, outputting at least part of information about contents of a generated event of the electronic device in response to the state where the electronic device is worn, and verifying authentication based on a state where the electronic device is not worn.

15. The method of claim 8, further comprising:
at least one of determining the proximity information and outputting information about the state where the electronic device is worn or a state where the electronic device is not worn, through the electronic device or an external electronic device or automatically determining whether a user of the electronic device enters a sleeping state, based on the physiological information, acceleration information, and gyro information.
